(19) United States
(12) Patent Application Publication
(10) Pub. No.: US 2023/0267378 A1
(43) Pub. Date: Aug. 24, 2023

(54) SYSTEMS, METHODS, AND STORAGE MEDIA FOR IDENTIFYING AN OBJECT IN A PHOTOGRAPH USING A MACHINE LEARNING SYSTEM

(71) Applicant: Earthsnap, Inc., Telluride, CO (US)

(72) Inventor: Eric Ralls, Telluride, CO (US)

(21) Appl. No.: 17/848,989

(22) Filed: Jun. 24, 2022

Related U.S. Application Data
(60) Provisional application No. 63/313,684, filed on Feb. 24, 2022.

(51) Int. Cl. G06N 20/20; G06F 16/11; G06F 16/955

(52) U.S. Cl. CPC G06N 20/20; G06F 16/128; G06F 16/955

(57) ABSTRACT

Systems, methods, and storage media for operating a machine learning system for identifying an object in a photograph are disclosed. The system is configured to prepare a plurality of data files for training the machine learning system by associating a label with each of the plurality of data files, splitting the plurality of data files into different data sets, including full, training, testing, and validation data sets, creating a final machine learning model based on metrics and/or artifacts associated with training on the full data set, and deploying the final machine learning model to a machine learning system endpoint. The system is further configured to identify at least one object in a user uploaded photograph based on invoking a first or a second trained model, the first or second trained model associated with the final machine learning model.

### CROSS-REFERENCE TO RELATED APPLICATIONS

The present application claims priority to U.S. Provisional Application No. 63/313,684 entitled “Systems, Methods, and Storage Media for Identifying an Object in a Photograph” filed Feb. 24, 2022, the contents of which are incorporated herein by reference in their entirety.

### FIELD OF THE DISCLOSURE

The present disclosure relates to systems, methods, and storage media for identifying an object in a photograph. More specifically, but without limitation, the present disclosure relates to systems, methods, and storage media for operating a machine learning system for identifying an object in a photograph.

### BACKGROUND

There is an overwhelming number of plant species on the earth from the most exotic locations to backyard environments. Often, hikers, climbers, backpackers, and gardeners may encounter unknown plant species. There is a need to facilitate identification using a convenient electronic platform when circumstances prevent identification through conventional methods.

The description provided in the Background section should not be assumed to be prior art merely because it is mentioned in or associated with this section. The Background section may include information that describes one or more aspects of the subject technology.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

One aspect of the present disclosure relates to a system configured for identifying an object in a photograph. The system may include one or more hardware processors configured by machine-readable instructions. The processor(s) may be configured to send an initial request to identify the object in the photograph from a user device to an application programming interface (API). The processor(s) may be configured to generate, at the API, a pre-signed URL associated with a storage system. The processor(s) may be configured to generate metadata associated with the initial request. The processor(s) may be configured to send an initial response to the initial request. The processor(s) may be configured to upload the photograph from a user device directly to a location associated with the pre-signed URL. The processor(s) may be configured to send a second request to identify the object in the photograph from the user device to the API. The processor(s) may be configured to provide a second response to the second request. The processor(s) may be configured to obtain the photograph from the storage system. The processor(s) may be configured to use the photograph to invoke a first trained model from a machine learning (ML) system endpoint. The processor(s) may be configured to use the photograph to invoke a second trained model from the machine learning system endpoint. The processor(s) may be configured to obtain from the second trained model a list of one or more most likely identification probabilities associated with the object. The processor(s) may be configured to update the metadata associated with the object at the API. The processor(s) may be configured to send a third request from the user device to the API, wherein the third request includes a request to receive information associated with the list of one or more most likely identification probabilities. The processor(s) may be configured to display at the user device one or more of the list of one or more most likely identification probabilities associated with the object, and information associated with the one or more of the list of one or more most likely identification probabilities associated with the object.

Another aspect of the present disclosure relates to a method for identifying an object in a photograph. The method may include sending an initial request to identify the object in the photograph from a user device to an application programming interface (API). The method may include generating, at the API, a pre-signed URL associated with a storage system. The method may include generating metadata associated with the initial request. The method may include sending an initial response to the initial request. The method may include uploading the photograph from a user device directly to a location associated with the pre-signed URL. The method may include sending a second request to identify the object in the photograph from the user device to the API. The method may include providing a second response to the second request. The method may include obtaining the photograph from the storage system. The method may include using the photograph to invoke a first trained model from a machine learning (ML) system endpoint. The method may include using the photograph to invoke a second trained model from the ML system endpoint. The method may include obtaining from the second trained model a list of one or more most likely identification probabilities associated with the object. The method may include updating the metadata associated with the object at the API. The method may include sending a third request from the user device to the API, wherein the third request includes a request to receive information associated with the list of one or more most likely identification probabilities. The method may include displaying at the user device one or more of the list of one or more most likely identification probabilities associated with the object, and information associated with the one or more of the list of one or more most likely identification probabilities associated with the object.

Yet another aspect of the present disclosure relates to a non-transient computer-readable storage medium having instructions embodied thereon, the instructions being executable by one or more processors to perform a method for identifying an object in a photograph. The method may include sending an initial request to identify the object in the photograph from a user device to an application programming interface (API). The method may include generating, at the API, a pre-signed URL associated with a storage system. The method may include generating metadata associated with the initial request. The method may include sending an initial response to the initial request. The method may include uploading the photograph from a user device directly to a location associated with the pre-signed URL. The method may include sending a second request to identify the object in the photograph from the user device to the API. The method may include providing a second response to the second request. The method may include obtaining the photograph from the storage system. The method may include using the photograph to invoke a first trained model from a machine learning (ML) system endpoint. The method may include using the photograph to invoke a second trained model from the ML system endpoint. The method may include obtaining from the second trained model a list of one or more most likely identification probabilities associated with the object. The method may include updating the metadata associated with the object at the API. The method may include sending a third request from the user device to the API, wherein the third request includes a request to receive information associated with the list of one or more most likely identification probabilities. The method may include displaying at the user device one or more of the list of one or more most likely identification probabilities associated with the object, and information associated with the one or more of the list of one or more most likely identification probabilities associated with the object.

One aspect of the present disclosure relates to a system configured for operating a machine-learning system. The system may include one or more hardware processors configured by machine-readable instructions. The processor(s) may be configured to prepare a plurality of data files for training by associating a label with each of the plurality of data files, identifying and fixing errors in the plurality of data files, and uploading the plurality of data files to a storage device. The processor(s) may be configured to obtain a versioning snapshot of the plurality of data files uploaded to a storage device. The processor(s) may be configured to provide metadata associated with the plurality of data files to the machine-learning system. The processor(s) may be configured to split the plurality data files into a training data set. In some implementations, the processor may be configured to split the plurality of data files into the training data set, where the training data set includes a test data set, and a validation data set. The processor(s) may be configured to create record Input/Output (TO) data files including a plurality of training set record IO files, a plurality of testing set record IO files, a plurality of validation set record IO files, and a plurality of full set record IO files. The processor(s) may be configured to merge the plurality of record IO files for each set. The processor(s) may be configured to pass the merged record IO files to the storage device. The processor(s) may be configured to identify hyperparameter settings for use in association with training the merged full set record IO files by selecting a portion of the merged testing IIO files and a portion of the merged validation IO files, applying a plurality of hyperparameters to the selected portion of the merged testing IO files and the selected portion of the merged validation IO files across a plurality of training jobs. The processor(s) may be configured to review one or more metrics related to the plurality of training jobs. The processor(s) may be configured to store artifacts related to the plurality of training jobs at the storage device. The processor(s) may be configured to use the identified hyperparameter settings and the artifacts to train the merged full set record IO files. The processor(s) may be configured to store one or more metrics and artifacts associated with training the merged full set record IO files. The processor(s) may be configured to use the one or more metrics and artifacts associated with training the merged full set record IO files to create a final machine learning model. The processor(s) may be configured to obtain the final machine learning (ML) model from a machine learning system registry. The processor(s) may be configured to deploy the final machine learning model to one or more machine learning system endpoints.

Another aspect of the present disclosure relates to a method for operating a machine-learning system. The method may include preparing a plurality of data files for training by associating a label with each of the plurality of data files, identifying and fixing errors in the plurality of data files, and uploading the plurality of data files to a storage device. The method may include obtaining a versioning snapshot of the plurality of data files uploaded to a storage device. The method may include providing metadata associated with the plurality of data files to the machine-learning system. The method may include splitting the plurality data files into a training data set, where the training data set may include one or more of a testing data set, and a validation data set. The method may include creating record IO data files including a plurality of training set record IO files, a plurality of testing set record IO files, a plurality of validation set record IO files, and a plurality of full set record IO files. The method may include merging the plurality of record TO files for each set. The method may include passing the merged record IO files to the storage device. The method may include identifying hyperparameter settings for use in association with training the merged full set record IO files by selecting a portion of the merged testing IO files and a portion of the merged validation IO files, applying a plurality of hyperparameters to the selected portion of the merged testing IO files and the selected portion of the merged validation IO files across a plurality of training jobs. The method may include reviewing one or more metrics related to the plurality of training jobs. The method may include storing artifacts related to the plurality of training jobs at the storage device. The method may include using the identified hyperparameter settings and the artifacts to train the merged full set record IO files. The method may include storing one or more metrics and artifacts associated with training the merged full set record IO files. The method may include using the one or more metrics and artifacts associated with training the merged full set record IO files to create a final machine learning (ML) model. The method may include obtaining the final ML model from a ML system registry. The method may include deploying the final ML model to one or more ML system endpoints (e.g., shown as ML system endpoint 550 in FIG. 5D.

Yet another aspect of the present disclosure relates to a non-transient computer-readable storage medium having instructions embodied thereon, the instructions being executable by one or more processors to perform a method for operating a machine-learning or ML system. The method may include preparing a plurality of data files for training by associating a label with each of the plurality of data files, identifying and fixing errors in the plurality of data files, and uploading the plurality of data files to a storage device. The method may include obtaining a versioning snapshot of the plurality of data files uploaded to a storage device. The method may include providing metadata associated with the plurality of data files to the machine-learning system. The method may include splitting the plurality data files into a training data set. The training data set may include one or more of a testing data set, and a validation data set. The method may include creating record IO data files including a plurality of training set record IO files, a plurality of testing set record IO files, a plurality of validation set record IO files, and a plurality of full set record IO files. The method may include merging the plurality of record IO files for each set. The method may include passing the merged record IO files to the storage device. The method may include identifying hyperparameter settings for use in association with training the merged full set record IO files by selecting a portion of the merged testing IO files and a portion of the merged validation IO files, applying a plurality of hyperparameters to the selected portion of the merged testing IO files and the selected portion of the merged validation IO files across a plurality of training jobs. The method may include reviewing one or more metrics related to the plurality of training jobs. The method may include storing artifacts related to the plurality of training jobs at the storage device. The method may include using the identified hyperparameter settings and the artifacts to train the merged full set record IO files. The method may include storing one or more metrics and artifacts associated with training the merged full set record IO files. The method may include using the one or more metrics and artifacts associated with training the merged full set record IO files to create a final machine learning or ML model. The method may include obtaining the final ML model from a ML system registry. The method may include deploying the final ML model to one or more ML system endpoints (e.g., shown as ML system endpoint 550 in FIG. 5D, ML platform 350 in FIG. 3C).

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1A illustrates a system configured for identifying an object in a photograph, in accordance with one or more implementations.

FIG. 1B illustrates a system configured for operating a machine learning system, in accordance with one or more implementations.

FIG. 2A illustrates a method for identifying an object in a photograph, in accordance with one or more implementations.

FIG. 2B illustrates a method for operating a machine learning system, according to various aspects of the disclosure.

FIG. 3A illustrates a diagrammatic representation of a system configured for identifying an object in a photograph, in accordance with various aspects of the disclosure.

FIG. 3B illustrates a diagrammatic representation of a system configured for identifying an object in a photograph, in accordance with various aspects of the disclosure.

FIG. 3C illustrates a diagrammatic representation of a system configured for identifying an object in a photograph, in accordance with various aspects of the disclosure.

FIG. 3D illustrates a diagrammatic representation of a system configured for identifying an object in a photograph, in accordance with various aspects of the disclosure.

FIG. 3E illustrates a diagrammatic representation of a system configured for identifying an object in a photograph, in accordance with various aspects of the disclosure.

FIG. 4 illustrates a block diagram of a computer system configured for identifying an object in a photograph, in accordance with various aspects of the disclosure.

FIG. 5A illustrates an example of a system configured for operating a machine learning system, for instance, for identifying an object in a photograph, according to various aspects of the disclosure.

FIG. 5B illustrates an example of a system configured for operating a machine learning system, for instance, for identifying an object in a photograph, according to various aspects of the disclosure.

FIG. 5C illustrates an example of a system configured for operating a machine learning system, for instance, for identifying an object in a photograph, according to various aspects of the disclosure.

FIG. 5D illustrates an example of a system configured for operating a machine learning system, for instance, for identifying an object in a photograph, according to various aspects of the disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The words “for example” is used herein to mean “serving as an example, instant, or illustration.” Any embodiment described herein as “for example” or any related term is not necessarily to be construed as preferred or advantageous over other embodiments. Additionally, a reference to a “device” is not meant to be limiting to a single such device. It is contemplated that numerous devices may comprise a single “device” as described herein.

The embodiments described below are not intended to limit the disclosure to the precise form disclosed, nor are they intended to be exhaustive. Rather, the embodiment is presented to provide a description so that others skilled in the art may utilize its teachings. Technology continues to develop, and elements of the described and disclosed embodiments may be replaced by improved and enhanced items, however the teaching of the present disclosure inherently discloses elements used in embodiments incorporating technology available at the time of this disclosure.

The detailed descriptions which follow are presented in part in terms of algorithms and symbolic representations of operations on data within a computer memory wherein such data often represents numerical quantities, alphanumeric characters or character strings, logical states, data structures, or the like. A computer generally includes one or more processing mechanisms for executing instructions, and memory for storing instructions and data.

When a general-purpose computer has a series of machine-specific encoded instructions stored in its memory, the computer executing such encoded instructions may become a specific type of machine, namely a computer particularly configured to perform the operations embodied by the series of instructions. Some of the instructions may be adapted to produce signals that control operation of other machines and thus may operate through those control signals to transform materials or influence operations far removed from the computer itself. These descriptions and representations are the means used by those skilled in the data processing arts to convey the substance of their work most effectively to others skilled in the art.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are often described in terms, such as comparing, sorting, selecting, or adding, which are commonly associated with mental operations performed by a human operator. It should be understood that these terms are employed to provide a clear description of an embodiment of the present invention, and no such human operator is necessary, nor desirable in most cases.

This requirement for machine implementation for the practical application of the algorithms is understood by those persons of skill in this art as not a duplication of human thought, rather as significantly more than such human capability. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, wherein some aspects of the algorithm are performed by the circuitry itself rather as a result of an instruction.

Some embodiments of the present invention rely on an apparatus for performing disclosed operations. This apparatus may be specifically constructed for the required purposes, or it may comprise a general purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. The required structure for a variety of these machines will be apparent from the description below.

In the following description, several terms which are used frequently have specialized meanings in the present context.

In the description of embodiments herein, frequent use is made of the terms server, client, and client/server architecture. In this context, a server and client are each instantiations of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that client and server each perform distinct, but complementary functions to accomplish a task or provide a service. The client and server accomplish this by exchanging data, messages, and often state information using a computer network, or multiple networks. It should be appreciated that in a client/server architecture for distributed computing, there are typically multiple servers and multiple clients, and they do not map to each other and further there may be more servers than clients or more clients than servers. A server is typically designed to interact with multiple clients.

In networks, bi-directional data communication (i.e., traffic) occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

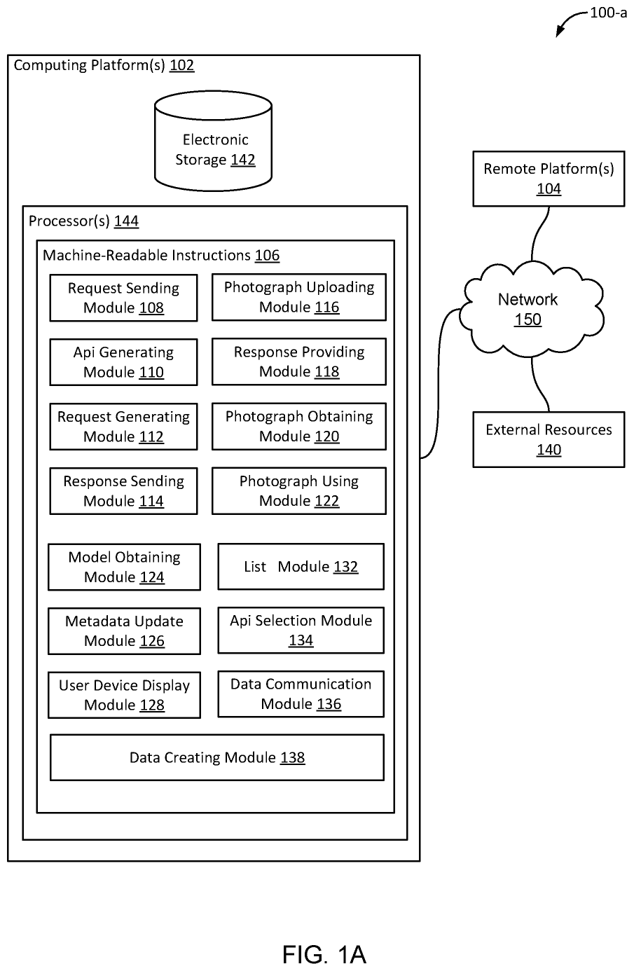

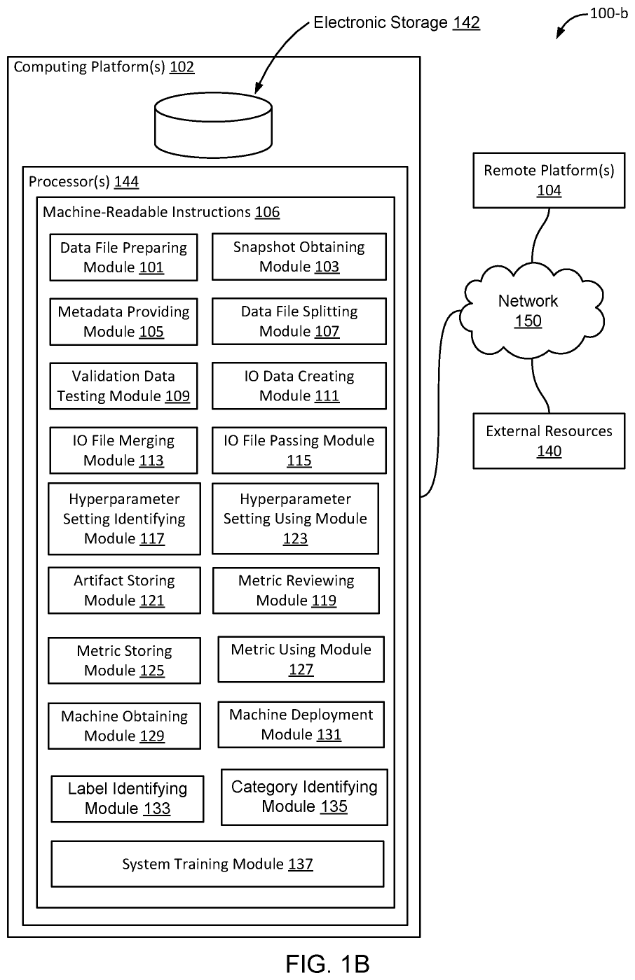

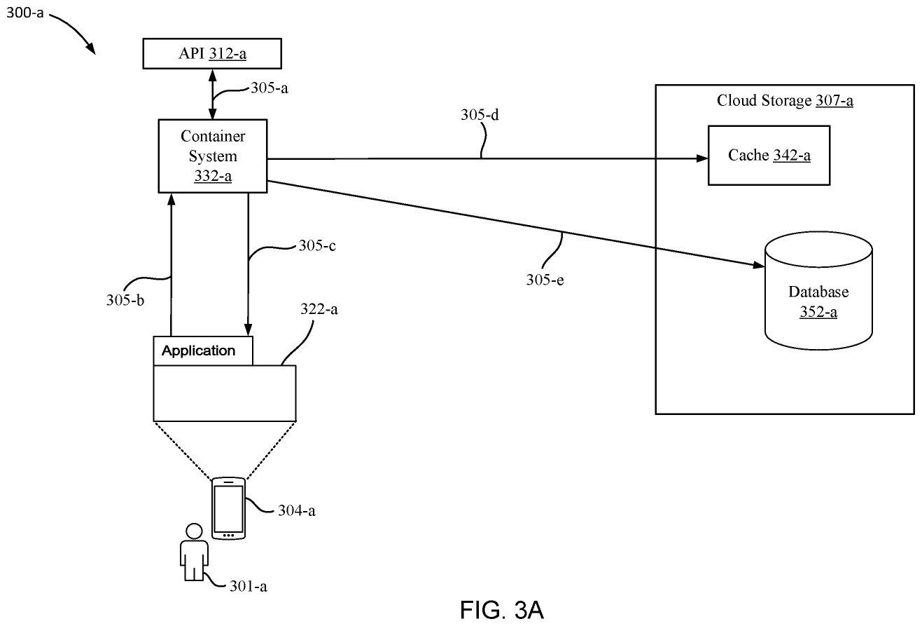

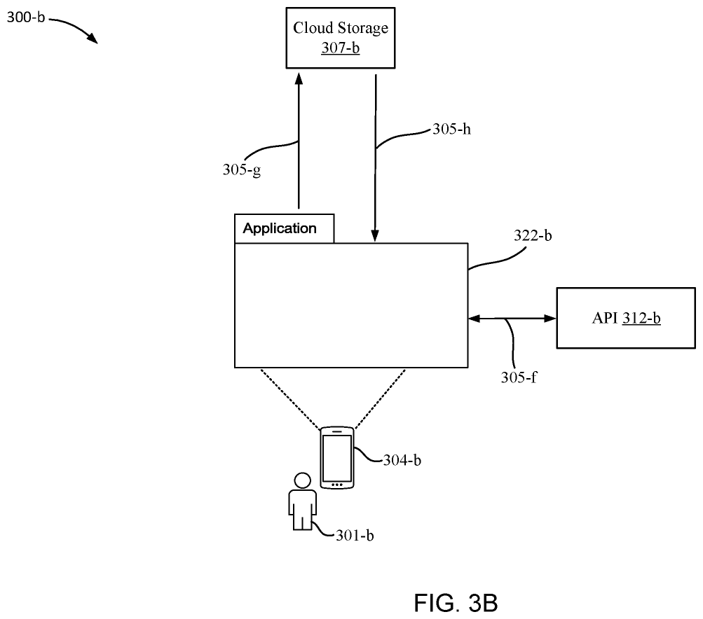

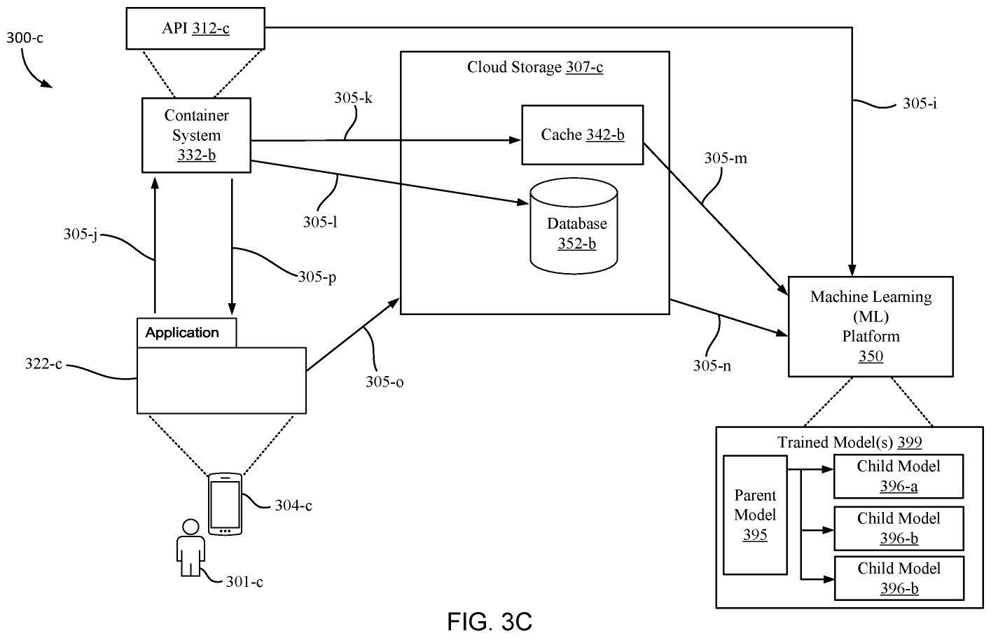

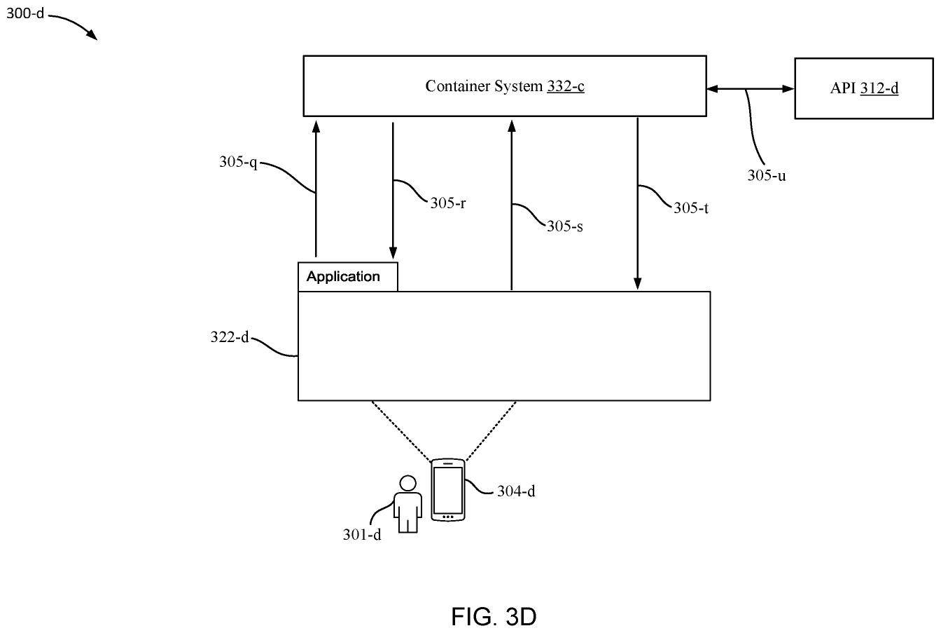

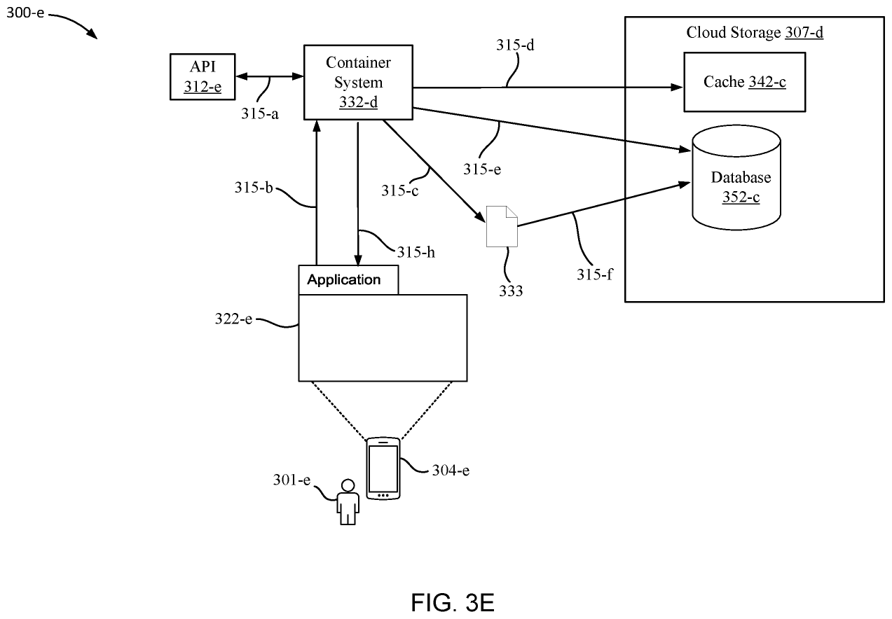

FIG. 1A illustrates a system 100-a configured for identifying an object in a photograph, in accordance with one or more implementations. In some implementations, system 100-a may include one or more servers 102. Server(s) 102 may be configured to communicate with one or more client computing platforms 104 according to a client/server architecture and/or other architectures. Client computing platform(s) 104 may be configured to communicate with other client computing platforms via a network 150, the server(s) 102, according to a peer-to-peer architecture and/or other architectures. Users may access system 100 via client computing platform(s) 104. The system 100-a may be similar or substantially similar to system(s) 300 (e.g., system 300-a, 300-b, etc.) and/or system 400, described later in relation to FIGS. 3A-3E and/or 4, respectively.

Server(s) 102 may be configured by machine-readable instructions 106. Machine-readable instructions 106 may include one or more instruction modules. The instruction modules may include computer program modules. The instruction modules may include one or more of request sending module 108, API generating module 110, request generating module 112, response sending module 114, photograph uploading module 116, response providing module 118, photograph obtaining module 120, photograph using module 122, model obtaining module 124, metadata update module 126, user device display module 128, UNNAMED_1 module 130, list module 132, API selection module 134, data communication module 136, data creating module 138, and/or other instruction modules.

Request sending module 108 may be configured to send an initial request to identify the object in the photograph from a user device to an application programming interface (API). The API may be similar or substantially similar to any of the APIs described herein, including at least API 312 (e.g., API 312-a, 312-b) or API 412.

Request sending module 108 may be configured to send a second request to identify the object in the photograph from the user device to the API. The second request may include at least a portion of the metadata. In some implementations, sending a second request to identify the object in the photograph from the user device to the API may include sending a plurality of second requests to identify the object in the photograph from the user device to the API. Each of the plurality of second requests to identify the object in the photograph after a first of the plurality of second requests to identify the object in the photograph may be sent at a predetermined period of time after the prior of the plurality of second requests to identify the object in the photograph. Ceasing sending the second requests to identify the object in the photograph when the list of one or more most likely identification probabilities associated with the object may be obtained. The plurality of second requests to identify the object in the photograph from the user device to the API may include a polling operation and hash information related to the metadata. The predetermined period of time may include a two second interval.

Request sending module 108 may be configured to send a third request from the user device to the API, wherein the third request includes a request to receive information associated with the list of one or more most likely identification probabilities. By way of non-limiting example, the information associated with the list of one or more most likely identification probabilities may include an object name (e.g., a species name of an insect, plant, animal, tree, etc.) for each of the most likely identification probabilities, an object description (e.g., a brief description of the insect, plant, animal, tree, etc.) for each of the most likely identification probabilities, a hash value associated with each of the most likely identification probabilities, and a photograph (e.g., an image of the plant, tree, animal, insect, etc.) for each of the most likely identification probabilities.

API generating module 110 may be configured to generate, at the API, a pre-signed URL associated with a storage system. The storage system may include a cloud-based image storage system. One non-limiting example of the cloud-based image storage system may include cloud storage 307 (e.g., cloud storage 307-a, cloud storage 307-b), as described below in relation to FIGS. 3B and/or 3C, respectively. In some implementations, the cloud-based image storage system (e.g., shown as cloud storage 307-b in FIG. 3C) may include AMAZON SIMPLE STORAGE SERVICE provided by AMAZON, INC., of Seattle, Wash., although other types of cloud-based image storage systems known in the art are also contemplated in different embodiments.

Request generating module 112 may be configured to generate metadata associated with the initial request. By way of non-limiting example, the metadata may include one or more of an image path, geographic location information associated with the photograph (e.g., global positioning system or GPS data for the location where the photograph was taken), user identification information (e.g., user credentials information, such as a username, email address, phone number, social media account information, to name a few), timing information (e.g., timestamp at which the initial request was sent/received, timestamp at which the metadata was generated, timestamp at which the photograph was taken, etc.), and a status of the request (e.g., no image, identification in progress, identification is complete, etc.). By way of non-limiting example, the status of the request may include a first status, a second status, a third status, and a fourth status. In some examples, at least one of the metadata and the photograph may be located in a cache associated with the cloud-based image storage system.

The first status may identify that the object has not been identified in the photograph and is set after the initial request. By way of non-limiting example, the second status may identify that identification of the object in the photograph is in progress and is set after the second request. The third status may include one of identification of the object is complete after receiving the list of one or more most likely identification probabilities and identification of the object is failed when the list of one or more most likely identification probabilities is not received. The fourth status may include an accepted status when the object is selected and a suggested status when the object name is suggested.

Response sending module 114 may be configured to send an initial response to the initial request. By way of non-limiting example, the initial response may include one of (1) a response including the pre-signed URL and at least a portion of the metadata, or (2) a response denying the initial request. By way of non-limiting example, the initial response denying the initial request may be provided when at least one of the API fails to identify at least one photograph due to an account setting associated with the photograph preventing identification of the photograph, and a security setting preventing identification of the photograph. In some implementations, the image path may include a data string identifying a location where the photograph is stored. By way of non-limiting example, the user identification information may include one or more of a data string associated with a user, a timestamp, and a data string associated with the request. In some implementations, the account setting may include a non-premium user account.

Photograph uploading module 116 may be configured to upload the photograph from a user device directly to a location associated with the pre-signed URL.

Response providing module 118 may be configured to provide a second response to the second request.

Photograph obtaining module 120 may be configured to obtain the photograph from the storage system (e.g., cloud-based storage system, such as cloud-based storage 307-a, 307-b).

In some examples, obtaining the photograph from the storage system includes using the metadata at the API to locate the photograph on the cloud-based image storage system.

Photograph using module 122 may be configured to use the photograph to invoke a first trained model from a machine learning (ML) system endpoint (e.g., shown as machine-learning platform 350 in FIG. 3C). In some implementations, using the photograph to invoke a first trained model from a ML system endpoint, such as machine-learning platform 350 in FIG. 3C, may include invoking the first trained model by the API. The first trained model may include a parent model (e.g., parent model 395 in FIG. 3C).

Photograph using module 122 may be configured to use the photograph to invoke a second trained model from the machine learning system endpoint. The second trained model may include a child model. Using the photograph to invoke the second trained model from the machine learning system endpoint may include using the parent model (e.g., parent model 395 in FIG. 3C) to invoke the child model (e.g., child model 396-a, 396-b, or 396-c in FIG. 3C). In some implementations, the parent model identifies (or may be used to identify) a category associated with the object. Additionally, or alternatively, the child model may identify at least one species associated with the category associated with the object.

By way of non-limiting example, the child model may include one of a “plant” child model, a “mammal” child model, an “insect” child model, an “amphibian” child model, a “fish” child model, a “bird” child model, and a “tree bark” child model. Other types of parent and child models are contemplated in different embodiments, and the examples listed herein are not intended to be limiting.

Model obtaining module 124 may be configured to obtain from the second trained model a list of one or more most likely identification probabilities associated with the object. In some circumstances, the list of one or more most likely identification probabilities may not be received (e.g., by the model obtaining module 124) when the ML system is unavailable. In some implementations, the list of objects (e.g., species) may include a hash value associated with the object or species.

Metadata update module 126 may be configured to update the metadata associated with the object at the API. In some implementations, updating the metadata associated with the object may include changing a status of the request to the third status. In some implementations, updating the metadata associated with the object may include providing a period of time associated with the period between sending the initial request to identify the object in a photograph and invoking a first trained model from a machine learning system endpoint. In some implementations, updating the metadata associated with the object may include providing a period of time associated with the period between sending an initial request to identify the object in a photograph and invoking a second trained model from a machine learning system endpoint. In some implementations, updating the metadata associated with the object may include changing a status of the request to the fourth status.

User device display module 128 may be configured to display at the user device one or more of the list of one or more most likely identification probabilities associated with the object, and information associated with the one or more of the list of one or more most likely identification probabilities associated with the object. By way of non-limiting example, the list of one or more most likely identification probabilities associated with the object may include the information associated with the list of one or more most likely identification probabilities, and a list of species. The list of one or more most likely identification probabilities associated with the object may include a list of objects.

List module 132 may be configured to select one of the list of objects at the user device, wherein the selected object includes an object most similar to the object in the photograph and/or suggesting an object name for the object in the photograph.

API selection module 134 may be configured to communicate with the API by providing the API with a hash value for the object (or species).

Data communication module 136 may be configured to create a data file associated with the one more of a selected object and the suggested object name, wherein the data file includes one or more of an image of the object, geolocation information, and at least a portion of the metadata information. In some implementations, the data communication module 136 may be configured to transmit a second response, where the second response informs the user device, from the API, that the image is being processed.

Data creating module 138 may be configured to associate the data file with a social media account and/or display the data file (e.g., an image of the object) within a social media account.

In some implementations, server(s) 102, client computing platform(s) 104, and/or external resources 140 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 140 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 140, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 140 may include sources of information outside of system 100, external entities participating with system 100, and/or other resources. In some implementations, some or all of the functionality attributed herein to external resources 140 may be provided by resources included in system 100.

Server(s) 102 may include electronic storage 142, one or more processors 144, and/or other components. Server(s) 102 may include communication lines, or ports to enable the exchange of information with a network 150 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 142 may comprise non-transitory storage media that electronically stores information. The electronic storage media of electronic storage 142 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 142 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 142 may include one or more virtual storage resources (e.g., cloud storage, a virtual private network, and/or other virtual storage resources). Electronic storage 142 may store software algorithms, information determined by processor(s) 144, information received from server(s) 102, information received from client computing platform(s) 104, and/or other information that enables server(s) 102 to function as described herein.

Processor(s) 144 may be configured to provide information processing capabilities in server(s) 102. As such, processor(s) 144 may include one or more of a digital processor, an analog processor, a digital circuit designed to process information, an analog circuit designed to process information, a state machine, and/or other mechanisms for electronically processing information. Although processor(s) 144 is shown in FIG. 1 as a single entity, this is for illustrative purposes only. In some implementations, processor(s) 144 may include a plurality of processing units. These processing units may be physically located within the same device, or processor(s) 144 may represent processing functionality of a plurality of devices operating in coordination. Processor(s) 144 may be configured to execute modules 108, 110, 112, 114, 116, 118, 120, 122, 124, 126, 128, 132, 134, 136, and/or 138, and/or other modules. Processor(s) 144 may be configured to execute modules 108, 110, 112, 114, 116, 118, 120, 122, 124, 126, 128, 132, 134, 136, and/or 138, and/or other modules by software; hardware; firmware; some combination of software, hardware, and/or firmware; and/or other mechanisms for configuring processing capabilities on processor(s) 144. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 132, 134, 136, and/or 138 are illustrated in FIG. 1 as being implemented within a single processing unit, in implementations in which processor(s) 144 includes multiple processing units, one or more of modules 108, 110, 112, 114, 116, 118, 120, 122, 124, 126, 128, 132, 134, 136, and/or 138 may be implemented remotely from the other modules. The description of the functionality provided by the different modules 108, 110, 112, 114, 116, 118, 120, 122, 124, 126, 128, 132, 134, 136, and/or 138 described below is for illustrative purposes, and is not intended to be limiting, as any of modules 108, 110, 112, 114, 116, 118, 120, 122, 124, 126, 128, 132, 134, 136, and/or 138 may provide more or less functionality than is described. For example, one or more of modules 108, 110, 112, 114, 116, 118, 120, 122, 124, 126, 128, 132, 134, 136, and/or 138 may be eliminated, and some or all of its functionality may be provided by other ones of modules 108, 110, 112, 114, 116, 118, 120, 122, 124, 126, 128, 132, 134, 136, and/or 138. As another example, processor(s) 144 may be configured to execute one or more additional modules that may perform some or all of the functionality attributed below to one of modules 108, 110, 112, 114, 116, 118, 120, 122, 124, 126, 128, 132, 134, 136, and/or 138.

FIG. 1B illustrates a system 100-b configured for operating a machine-learning system, in accordance with one or more implementations. System 100-b implements one or more aspects of the other systems described herein, including at least system 100-a, system(s) 300, and/or computing system(s) 400. In some implementations, system 100-b may include one or more servers 102, which may be similar or substantially similar to the server 102 described in relation to FIG. 1A. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. In some examples, users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of data file preparing module 101, snapshot obtaining module 103, metadata providing module 105, plurality data file splitting module 107, validation data testing module 109, Input/Output (IO) data creating module 111, IO file merging module 113, IO file passing module 115, hyperparameter setting identifying module 117, metric reviewing module 119, artifact storing module 121, hyperparameter setting using module 123, metric storing module 125, metric using module 127, machine learning (ML) model obtaining module 129, ML deployment module 131, label identifying module 133, category identifying module 135, system training module 137, and/or other instruction modules.

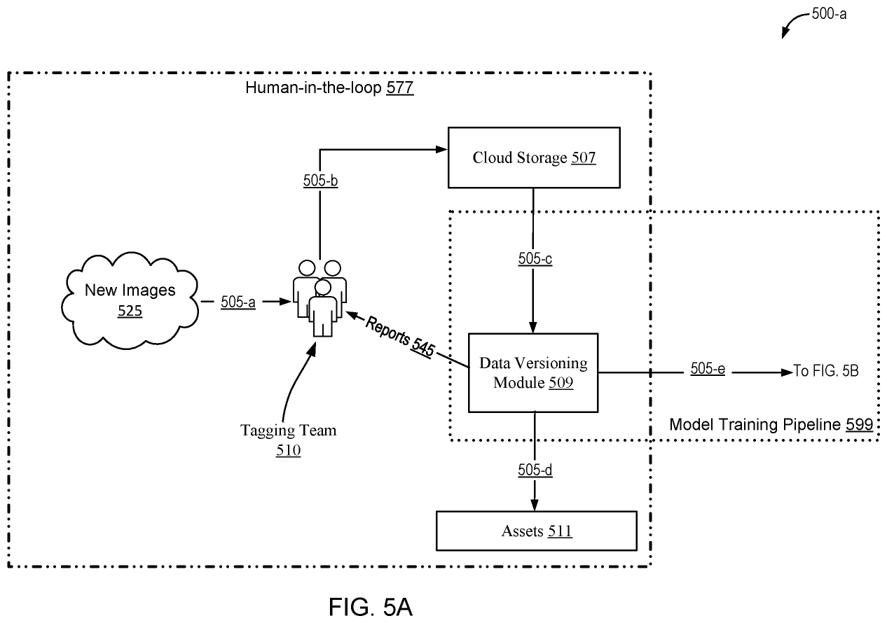

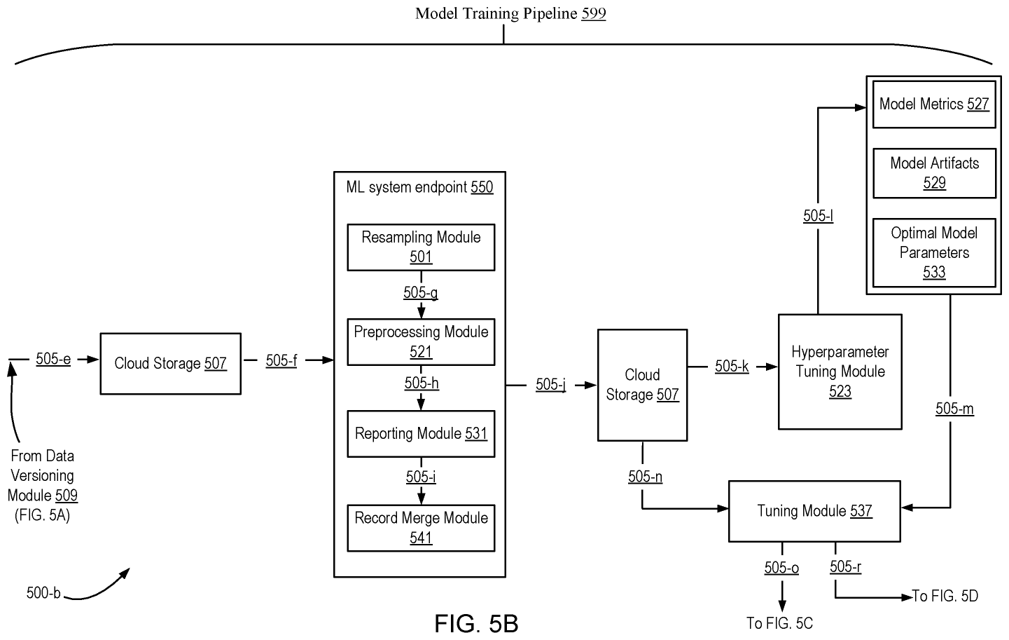

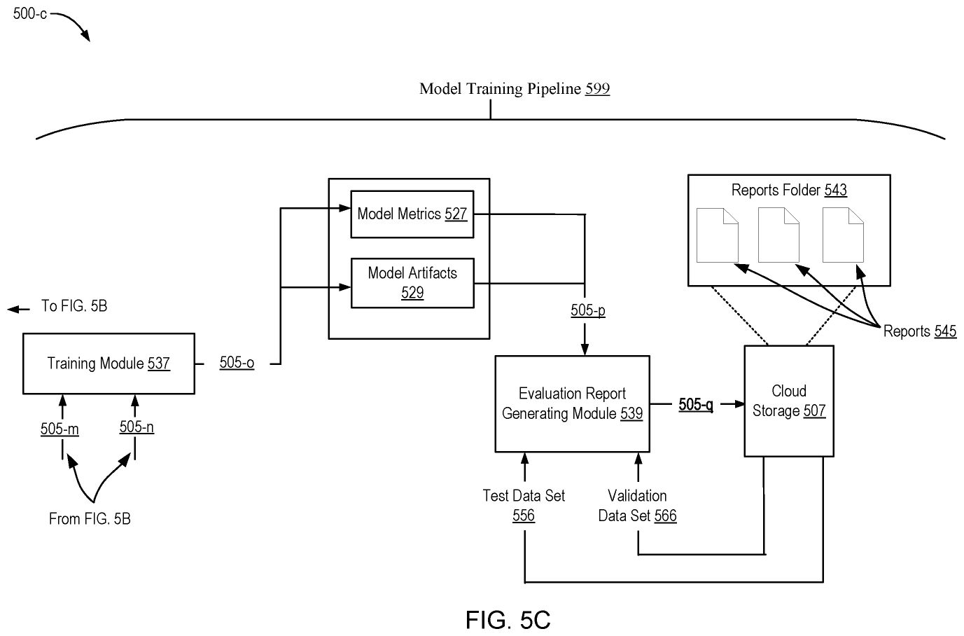

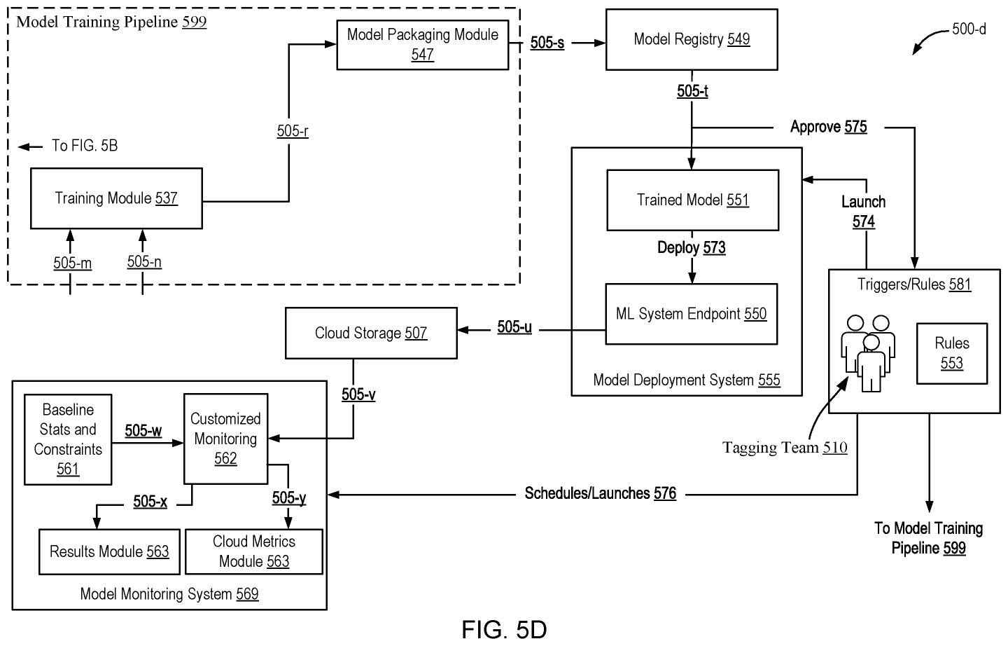

Data file preparing module 101 may be configured to prepare a plurality of data files for training by associating a label with each of the plurality of data files, identifying and fixing errors in the plurality of data files, and uploading the plurality of data files to a storage device. In some examples, the storage device comprises a cloud-based storage system (or cloud storage), such as cloud storage 507 in FIG. 5A. The label may include one of a predetermined category and a species associated with one of the predetermined categories. In some implementations, uploading the plurality of data files to a storage device, such as cloud storage 507, may include uploading the plurality of data files to a folder on the cloud-based storage system. The folder name may include the label.

Snapshot obtaining module 103 may be configured to obtain a versioning snapshot of the plurality of data files uploaded to a storage device. The plurality of data files uploaded to the storage device may include images of at least one of a plurality of the predetermined categories. The storage device may include a cloud-based storage system. In some examples, when the plurality of data files uploaded to the storage device include images of a plurality of the predetermined categories, the plurality of data files may include at least 100 images for each of the plurality of predetermined categories included in the plurality of data files. It should be noted that, the number of images for each of the plurality of predetermined categories is not intended to be limiting. More or less than 100 images are contemplated in different embodiments. For instance, the plurality of data files may include at least 50 images or at least 200 images or at least 500 images or at least 1000 images for each of the plurality of predetermined categories included in the plurality of data files, in some embodiments. By way of non-limiting example, training the machine-learning (or ML) system, such as the ML system endpoint 550 in FIG. 5D, on the same number of data files for each category includes (1) determining a fewest number of data files associated with a single predetermined category across all predetermined categories identified in the plurality of data files, (2) having a number of data files greater than the fewest number of data files for all predetermined categories identified in the plurality of data files and randomly selecting an amount of data files to equal the fewest number of data files, and (3) training the machine-learning system on the fewest number of data files associated with the single predetermined category and the randomly selected data files for each of the predetermined categories identified as having a number of data files greater than the fewest number.

In some implementations, identifying and fixing errors in the plurality of data files may include identifying and fixing mismatches in the plurality of data files. In some implementations, the testing data set may include at or around 10% of the plurality of data files. By way of non-limiting example, the validation data set may include at or around 10% of the plurality of data files, and the full data set includes at or around 100% of the plurality of data files.

Metadata providing module 105 may be configured to provide metadata associated with the plurality of data files to the machine-learning system. The metadata may include the label and a uniform resource identifier (URI).

Data file splitting module 107 may be configured to split the plurality of data files into a training data set, where the training data set may include 80% of the plurality of data files. In other cases, the training data set may include more or less than 80% of the plurality of data files. For example, the training data set may include 50% or 60% or 85% or 90% of the plurality of data files, in some examples. Additionally, or alternatively, the data file splitting module 107 may be configured to split the plurality of data files into a training data set, a testing data set, and a validation data set.

Additionally, or alternatively, a validation data testing module 109 may be configured to generate the training data set, the testing data set, and the validation data set, based on splitting the plurality of data files. In some implementations, the validation data set comprises 10% of the plurality of data files, the testing data set comprises 10% of the plurality of data files, and the training data set comprises 80% of the plurality of data files. Other ratios/percentages for the validation data set, testing data set, and training data set are contemplated in different embodiments, and the examples listed herein are not intended to be limiting.

Input/Output (IO) data creating module 111 may be configured to create record IO data files including a plurality of training set record IO files, a plurality of testing set record IO files, a plurality of validation set record IO files, and a plurality of full set record IO files.

IO data creating module 111 may be configured to, after creating record io data files, report information about each data set. By way of non-limiting example, the information about each data set may include one or more of a JavaScript Object Notation (JSON) file, a total image count in each data set (e.g., training data set, testing data set, and/or validation data set), and a corrupted images count in each data set.

IO file merging module 113 may be configured to merge the plurality of record IO files for each data set (simply referred to as set, in some examples).

IO file passing module 115 may be configured to pass the merged record IO files to the storage device.

Hyperparameter setting identifying module 117 may be configured to identify hyperparameter settings for use in association with training the merged full set record IO files by (1) selecting a portion of the merged testing IO files and a portion of the merged validation IO files, (2) applying a plurality of hyperparameters to the selected portion of the merged testing IO files, and (3) applying the plurality of hyperparameters to the selected portion of the merged validation IO files across a plurality of training jobs.

Metric reviewing module 119 may be configured to review one or more metrics related to the plurality of training jobs.

Artifact storing module 121 may be configured to store artifacts related to the plurality of training jobs at the storage device. In some examples, an output of the training jobs may include identification information related to an object in the images.

Hyperparameter setting using module 123 may be configured to use the identified hyperparameter settings and the artifacts to train the merged full set record IO files.

Metric storing module 125 may be configured to store one or more metrics and artifacts associated with training the merged full set record IO files. The one or more metrics may include a percentage of the identification information which accurately identifies the object in the images. The one or more metrics may be reviewed with a machine learning system report (e.g., shown as reports 545 in reports folder 543 in FIG. 5C).

Metric using module 127 may be configured to use the one or more metrics and artifacts associated with training the merged full set record IO files to create a final machine learning model. In some examples, when the label includes a predetermined category, the final machine learning model includes a first trained model, where the first trained model includes a parent model (e.g., parent model 395 in FIG. 3C). When the label includes a species associated with one of the predetermined categories, the final machine learning model includes a second trained model, where the second trained model includes a child model (e.g., child model(s) 396 in FIG. 3C). By way of non-limiting example, (1) identifying the predetermined categories associated with the plurality of data files, and (2) training the machine-learning system on the same number of data files for each identified category may occur after providing metadata associated with the plurality of data files to the machine-learning system and before splitting the plurality of data files into the training data set, the testing data set, and the validation data set.

ML model obtaining module 129 may be configured to obtain the final machine learning model from a machine learning system registry (e.g., shown as model registry 549 in FIG. 5D). In some implementations, using the fewest number of data files (e.g., across all predetermined categories identified in the plurality of data files) to train the machine-learning system may include decreasing a bias in the machine learning system towards any particular category of the identified categories. In some cases, training the model on the same (or approximately the same) number of images may serve to reduce the bias towards any one category (e.g., plants) in the model. It should be noted that, typically, there may be little to no bias associated with a training model for a particular category (e.g., plant category, animal category, etc.) since there may be hundreds to thousands of species in each category. As such, the likelihood of a bias in the training model for a particular category is minimized.

ML deployment module 131 may be configured to deploy the final machine learning model to one or more machine learning system endpoints, such as, but not limited ML system endpoint 550. In some implementations, the artifacts may include assets (e.g., shown as assets 511 in FIG. 5A) to reproduce the model.

Label identifying module 133 may be configured to determine a plurality of label for each of the plurality of data files, where each of the plurality of data files is associated with one label of the plurality of labels. In some examples, the label includes a predetermined category and/or a species associated with one of the predetermined categories (e.g., plant, animal, insect, tree bark, birds, fishes, etc.). In some examples, the plurality of data files may be uploaded to a storage device, such as cloud storage 307, 507. In some cases, the uploading may include uploading the plurality of data files to a folder on the cloud-based storage system and the folder name for the folder may include the label. In other cases, the folder name may be based on the label (e.g., a shortened or abbreviated version of the label).

Category identifying module 135 may be configured to identify the predetermined categories associated with the plurality of data files.

System training module 137 may be configured to, when the label includes a predetermined category, train the machine-learning system on the same number of data files for each identified category.

In some implementations, the predetermined categories may include eight categories. In some implementations, by way of non-limiting example, the eight categories may include or are otherwise associated with plants, mammals, insects, amphibians, fish, birds, tree bark, and snails. In some implementations, by way of non-limiting example, the species may include one of a plant species, a mammal species, an insect species, an amphibian species, a fish species, a bird species, a tree bark species, and a snail species. In some implementations, the species may be associated with one of the predetermined categories. In some implementations, the folder on the cloud-based storage system may include a folder name.

In some implementations, server(s) 102, client computing platform(s) 104, and/or external resources 140 may be operatively linked via one or more electronic communication links. For example, such electronic communication links may be established, at least in part, via a network 150 such as the Internet and/or other networks. It will be appreciated that this is not intended to be limiting, and that the scope of this disclosure includes implementations in which server(s) 102, client computing platform(s) 104, and/or external resources 140 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 140, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 140 may include sources of information outside of system 100, external entities participating with system 100, and/or other resources. In some implementations, some or all of the functionality attributed herein to external resources 140 may be provided by resources included in system 100.

Server(s) 102 may include electronic storage 142, one or more processors 144, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 142 may comprise non-transitory storage media that electronically stores information. The electronic storage media of electronic storage 142 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 142 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 142 may include one or more virtual storage resources (e.g., cloud storage, a virtual private network, and/or other virtual storage resources). Electronic storage 142 may store software algorithms, information determined by processor(s) 144, information received from server(s) 102, information received from client computing platform(s) 104, and/or other information that enables server(s) 102 to function as described herein.

Processor(s) 144 may be configured to provide information processing capabilities in server(s) 102. As such, processor(s) 144 may include one or more of a digital processor, an analog processor, a digital circuit designed to process information, an analog circuit designed to process information, a state machine, and/or other mechanisms for electronically processing information. Although processor(s) 144 is shown in FIG. 1 as a single entity, this is for illustrative purposes only. In some implementations, processor(s) 144 may include a plurality of processing units. These processing units may be physically located within the same device, or processor(s) 144 may represent processing functionality of a plurality of devices operating in coordination. Processor(s) 144 may be configured to execute modules 101, 103, 105, 107, 109, 111, 113, 115, 117, 119, 121, 123, 125, 127, 129, 131, 133, 135, and/or 137, and/or other modules. Processor(s) 144 may be configured to execute modules 101, 103, 105, 107, 109, 111, 113, 115, 117, 119, 121, 123, 125, 127, 129, 131, 133, 135, and/or 137, and/or other modules by software; hardware; firmware; some combination of software, hardware, and/or firmware; and/or other mechanisms for configuring processing capabilities on processor(s) 144. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 101, 103, 105, 107, 109, 111, 113, 115, 117, 119, 121, 123, 125, 127, 129, 131, 133, 135, and/or 137 are illustrated in FIG. 1 as being implemented within a single processing unit, in implementations in which processor(s) 144 includes multiple processing units, one or more of modules 101, 103, 105, 107, 109, 111, 113, 115, 117, 119, 121, 123, 125, 127, 129, 131, 133, 135, and/or 137 may be implemented remotely from the other modules. The description of the functionality provided by the different modules 101, 103, 105, 107, 109, 111, 113, 115, 117, 119, 121, 123, 125, 127, 129, 131, 133, 135, and/or 137 described below is for illustrative purposes, and is not intended to be limiting, as any of modules 101, 103, 105, 107, 109, 111, 113, 115, 117, 119, 121, 123, 125, 127, 129, 131, 133, 135, and/or 137 may provide more or less functionality than is described. For example, one or more of modules 101, 103, 105, 107, 109, 111, 113, 115, 117, 119, 121, 123, 125, 127, 129, 131, 133, 135, and/or 137 may be eliminated, and some or all of its functionality may be provided by other ones of modules 101, 103, 105, 107, 109, 111, 113, 115, 117, 119, 121, 123, 125, 127, 129, 131, 133, 135, and/or 137. As another example, processor(s) 144 may be configured to execute one or more additional modules that may perform some or all of the functionality attributed below to one of modules 101, 103, 105, 107, 109, 111, 113, 115, 117, 119, 121, 123, 125, 127, 129, 131, 133, 135, and/or 137.

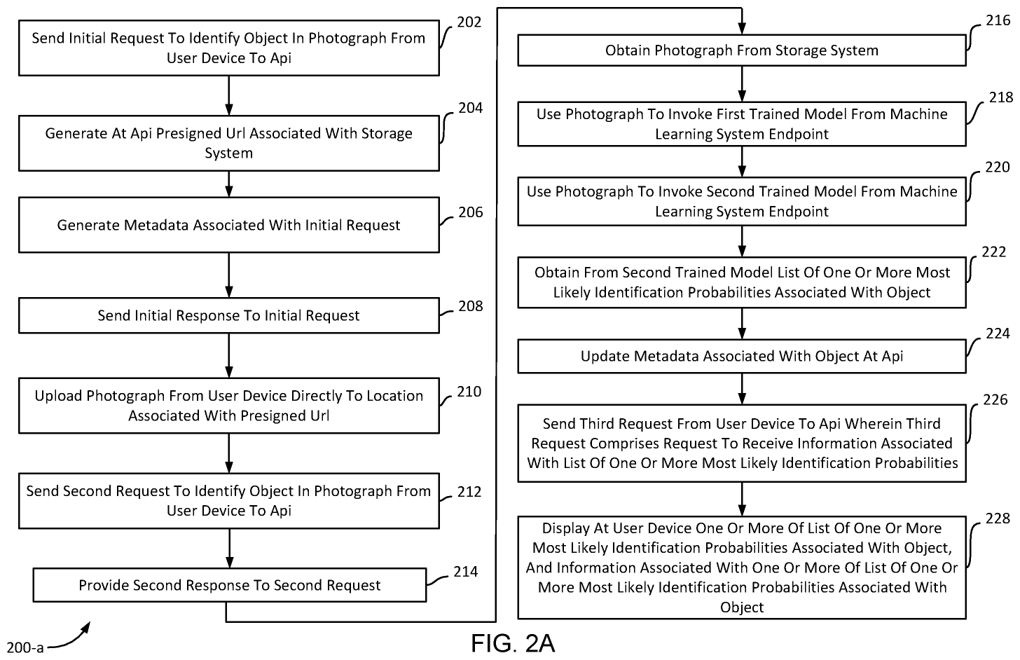

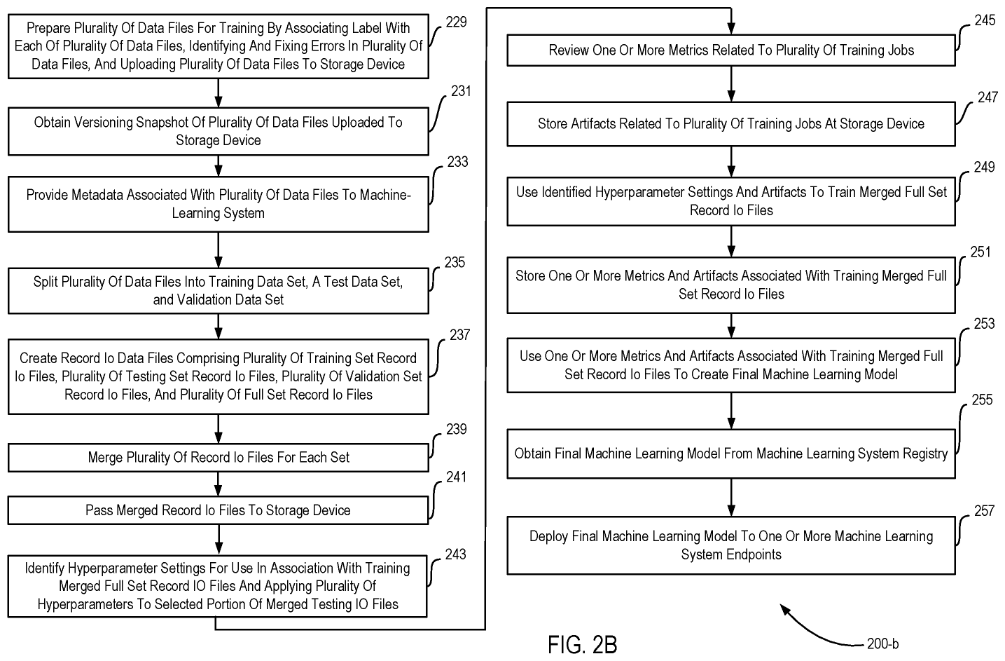

FIG. 2A illustrates a method 200-a for identifying an object in a photograph, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

A first operation 202 may include sending an initial request to identify the object in the photograph from a user device to an API. First operation 202 may be performed by one or more hardware processors configured by machine-readable instructions including a module that is the same as or similar to request sending module 108, in accordance with one or more implementations.

A second operation 204 may include generating, at the API, a pre-signed URL associated with a storage system. In some implementations, the storage system comprises a cloud-based storage system, such as cloud storage 307-a in FIG. 3B. In one non-limiting example, the pre-signed URL comprises a pre-signed S3 upload URL. This pre-signed URL may be used to place the image/photograph into a S3 bucket (e.g., a cloud object storage service provided by AMAZON SIMPLE STORAGE SERVICE of Amazon, Inc., of Seattle, Wash.). Second operation 204 may be performed by one or more hardware processors configured by machine-readable instructions including a module that is the same as or similar to API generating module 110, in accordance with one or more implementations.

A third operation 206 may include generating metadata associated with the initial request. In some cases, the metadata associated with the initial request includes one or more of a file path to the image/photograph (e.g., a string), latitude and longitude information (e.g., a number), user ID information (e.g., a string), timestamp data, unique identifier, and a status. Third operation 206 may be performed by one or more hardware processors configured by machine-readable instructions including a module that is the same as or similar to request generating module 112, in accordance with one or more implementations.

A fourth operation 208 may include sending an initial response to the initial request. Fourth operation 208 may be performed by one or more hardware processors configured by machine-readable instructions including a module that is the same as or similar to response sending module 114, in accordance with one or more implementations.

A fifth operation 210 may include uploading the photograph from a user device (e.g., user device 301-a in FIG. 3A) directly to a location associated with the pre-signed URL. Fifth operation 210 may be performed by one or more hardware processors configured by machine-readable instructions including a module that is the same as or similar to photograph uploading module 116, in accordance with one or more implementations.

A sixth operation 212 may include sending a second request to identify the object in the photograph from the user device to the API (e.g., shown as API 312-a in FIG. 3A). Sixth operation 212 may be performed by one or more hardware processors configured by machine-readable instructions including a module that is the same as or similar to request sending module 108, in accordance with one or more implementations.

A seventh operation 214 may include providing a second response to the second request. Seventh operation 214 may be performed by one or more hardware processors configured by machine-readable instructions including a module that is the same as or similar to response providing module 118, in accordance with one or more implementations.

An eighth operation 216 may include obtaining the photograph from the storage system (e.g., cloud storage 307-a in FIG. 3B). Eighth operation 216 may be performed by one or more hardware processors configured by machine-readable instructions including a module that is the same as or similar to photograph obtaining module 120, in accordance with one or more implementations.

A ninth operation 218 may include using the photograph to invoke a first trained model from a machine learning system endpoint. Ninth operation 218 may be performed by one or more hardware processors configured by machine-readable instructions including a module that is the same as or similar to photograph using module 122, in accordance with one or more implementations.

A tenth operation 220 may include using the photograph to invoke a second trained model from the machine learning (ML) system endpoint, such as the ML platform 350 in FIG. 3C. Tenth operation 220 may be performed by one or more hardware processors configured by machine-readable instructions including a module that is the same as or similar to photograph using module 122, in accordance with one or more implementations.

An eleventh operation 222 may include obtaining, from the second trained model, a list of one or more most likely identification probabilities associated with the object. Eleventh operation 222 may be performed by one or more hardware processors configured by machine-readable instructions including a module that is the same as or similar to model obtaining module 124, in accordance with one or more implementations.

A twelfth operation 224 may include updating the metadata associated with the object at the API. Twelfth operation 224 may be performed by one or more hardware processors configured by machine-readable instructions including a module that is the same as or similar to metadata update module 126, in accordance with one or more implementations.

A thirteenth operation 226 may include sending a third request from the user device to the API wherein the third request includes a request to receive information associated with the list of one or more most likely identification probabilities. Thirteenth operation 226 may be performed by one or more hardware processors configured by machine-readable instructions including a module that is the same as or similar to request sending module 108, in accordance with one or more implementations.

A fourteenth operation 228 may include displaying, at the user device, one or more of the list of one or more most likely identification probabilities associated with the object, and information associated with the one or more of the list of one or more most likely identification probabilities associated with the object. Fourteenth operation 228 may be performed by one or more hardware processors configured by machine-readable instructions including a module that is the same as or similar to user device display module 128, in accordance with one or more implementations.

FIG. 2B illustrates a method 200-b for operating a machine-learning system, in accordance with one or more implementations. In some examples, the machine-learning system may be used to help identify an object in a photograph, according to various aspects of the disclosure. The machine-learning system may be similar or substantially similar to the ML platform 350 and/or the ML system endpoint 550 described later in the disclosure. The operations of method 200-b presented below are intended to be illustrative. In some implementations, method 200-b may be accomplished with one or more additional operations not described, and/or without one or more of the operations discussed. Additionally, the order in which the operations of method 200-b are illustrated in FIG. 2B and described below is not intended to be limiting.

In some implementations, method 200-b may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200-b in response to instructions stored electronically on an electronic storage medium. The one or more processing devices may include one or more devices configured through hardware, firmware, and/or software to be specifically designed for execution of one or more of the operations of method 200-b.

A first operation 229 may include preparing a plurality of data files for training by associating a label with each of the plurality of data files, identifying and fixing errors in the plurality of data files, and uploading the plurality of data files to a storage device. First operation 229 may be performed by one or more hardware processors configured by machine-readable instructions including a module that is the same as or similar to data file preparing module 101, in accordance with one or more implementations.

A second operation 231 may include obtaining a versioning snapshot of the plurality of data files uploaded to a storage device. Second operation 231 may be performed by one or more hardware processors configured by machine-readable instructions including a module that is the same as or similar to snapshot obtaining module 103, in accordance with one or more implementations.

A third operation 233 may include providing metadata associated with the plurality of data files to the machine-learning system. Third operation 233 may be performed by one or more hardware processors configured by machine-readable instructions including a module that is the same as or similar to metadata providing module 105, in accordance with one or more implementations.

A fourth operation 235 may include splitting the plurality of data files into a training data set, a test data set, and a validation data set. Fourth operation 235 may be performed by one or more hardware processors configured by machine-readable instructions including a module that is the same as or similar to data file splitting module 107, in accordance with one or more implementations.

A fifth operation 237 may include creating record IO data files including a plurality of training set record IO files, a plurality of testing set record IO files, a plurality of validation set record IO files, and a plurality of full set record IO files. Fifth operation 237 may be performed by one or more hardware processors configured by machine-readable instructions including a module that is the same as or similar to IO data creating module 111, in accordance with one or more implementations.

A sixth operation 239 may include merging the plurality of record io files for each set. Sixth operation 239 may be performed by one or more hardware processors configured by machine-readable instructions including a module that is the same as or similar to IO file merging module 113, in accordance with one or more implementations.

A seventh operation 241 may include passing the merged record io files to the storage device. Seventh operation 241 may be performed by one or more hardware processors configured by machine-readable instructions including a module that is the same as or similar to IO file passing module 115, in accordance with one or more implementations.

An eighth operation 243 may include identifying hyperparameter settings for use in association with training the merged full set record IO files by selecting a portion of the merged testing IO files and a portion of the merged validation IO files, applying a plurality of hyperparameters to the selected portion of the merged testing IO files and the selected portion of the merged validation IO files across a plurality of training jobs. Eighth operation 243 may be performed by one or more hardware processors configured by machine-readable instructions including a module that is the same as or similar to hyperparameter setting identifying module 117, in accordance with one or more implementations.

A ninth operation 245 may include reviewing one or more metrics related to the plurality of training jobs. Ninth operation 245 may be performed by one or more hardware processors configured by machine-readable instructions including a module that is the same as or similar to metric reviewing module 119, in accordance with one or more implementations.

A tenth operation 247 may include storing artifacts related to the plurality of training jobs at the storage device. Tenth operation 247 may be performed by one or more hardware processors configured by machine-readable instructions including a module that is the same as or similar to artifact storing module 121, in accordance with one or more implementations.

A eleventh operation 249 may include using the identified hyperparameter settings and the artifacts to train the merged full set record IO files. Eleventh operation 249 may be performed by one or more hardware processors configured by machine-readable instructions including a module that is the same as or similar to hyperparameter setting using module 123, in accordance with one or more implementations.

A twelfth operation 251 may include storing one or more metrics and artifacts associated with training the merged full set record io files. Twelfth operation 251 may be performed by one or more hardware processors configured by machine-readable instructions including a module that is the same as or similar to metric storing module 125, in accordance with one or more implementations.

A thirteenth operation 253 may include using the one or more metrics and artifacts associated with training the merged full set record IO files to create a final machine learning model. Thirteenth operation 253 may be performed by one or more hardware processors configured by machine-readable instructions including a module that is the same as or similar to metric using module 127, in accordance with one or more implementations.

A fourteenth operation 255 may include obtaining the final machine learning model from a machine learning system registry. Fourteenth operation 255 may be performed by one or more hardware processors configured by machine-readable instructions including a module that is the same as or similar to machine obtaining module 129, in accordance with one or more implementations.

A fifteenth operation 257 may include deploying the final machine learning model to one or more machine learning system endpoints. Fifteenth operation 257 may be performed by one or more hardware processors configured by machine-readable instructions including a module that is the same as or similar to machine deployment module 131, in accordance with one or more implementations.

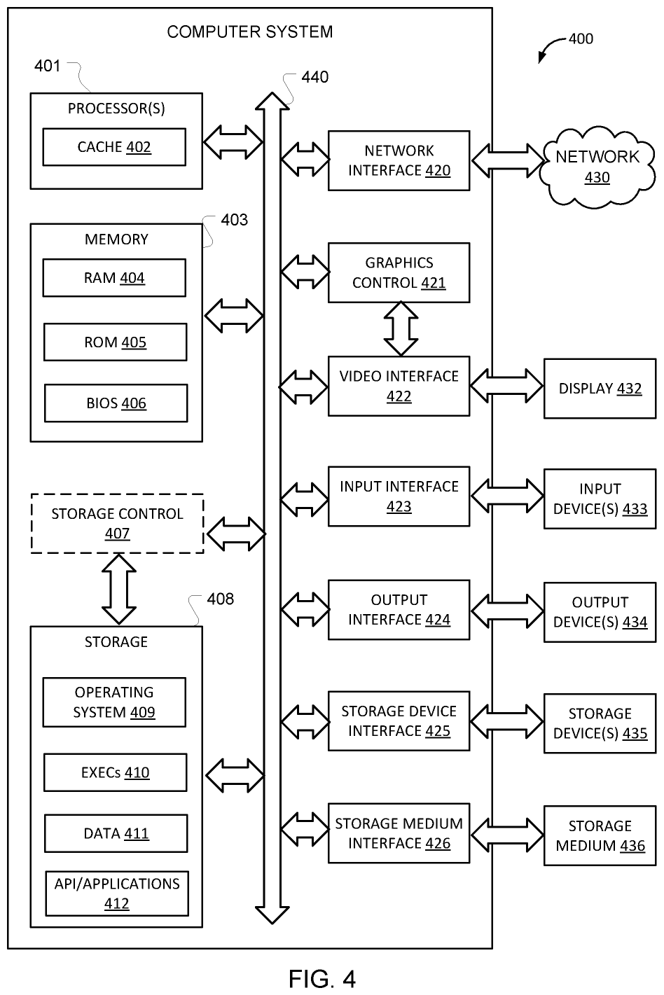

FIGS. 3A-3E depict diagrammatic representations of a system 300 (e.g., system 300-a . . . e) configured for identifying an object in a photograph, according to various aspects of the disclosure. The system(s) 300 may be similar or substantially to the system 100 described above in relation to FIG. 1. Further, the system(s) 300 may implement one or more aspects of the computer system 400 described in relation to FIG. 4.

Turning now to FIG. 3A, which illustrates a diagrammatic representation of a system 300-a configured for identifying an object in a photograph, in accordance with one or more implementations. As seen, the system 300-a comprises a user device 304-a configured to run (or execute) an application 322-a, a container system 332-a, and a cloud storage system 307-a. The cloud storage system 307-a includes a cache 342-a and a database 352-a. The user device 304-a is associated with a user 301-a. In some examples, the application 322-a is associated with an application programming interface (API) 312-a, where the API 312-a facilitates communications between the application 322-a and one or more external applications, computing systems, or computer programs. For example, the API 312-a helps establish a communication link between the application 322-a, the container system 332-a, and the cloud storage 307-a.

In some examples, the user 301-a may send an initial request (shown by dataflows 305-a and 305-b) to identify at least one object in at least one image/photograph from the user device 304-a to the API 312-a. In some examples, the application 322-a initializes the process of identification by requesting the API 312-a to check for permissions (e.g., user authorization, if the number of snaps is equal to or greater than a threshold). The API 312-a conducts one or more security checks (e.g., checks whether the user 301-a has a premium user account) and generates a response (e.g., Yes/No) to the initial request, where the response (shown by dataflow 305-c) indicates whether the user 301-a has permission to identify the image. In some examples, the API 312-a is deployed on (or associated with) the container system 332-a. One non-limiting example of a container system may include KUBERNETES, although other container systems are contemplated in different embodiments. The container system 332-a may enable the management/deployment of one or more applications (e.g., application 322-a) having one or more configurations inside a cloud service provider, such as AMAZON WEB SERVICES (AWS) provided by AMAZON, Inc., of Seattle, Wash. The container system 332-a may help handle scaling, application or API updates, manage the server load, and/or handle requests (including at least the initial request), to name a few non-limiting examples. Next, the API 312-a generates a pre-signed URL (e.g., a pre-signed S3 upload URL, where S3 refers to a cloud storage service provided by AMAZON, Inc., of Seattle, Wash.) and a unique identifier (or ID) for this identification batch. As used herein, the term “identification batch” refers to a batch/collection of images or photographs (i.e., associated with one or more objects) on which the disclosed image identification techniques may be effectuated. In some cases, the identification batch comprises the photograph/image of the object that the user 301-a wishes to identify. Additionally, or alternatively, the identification batch includes one or more object photographs/images that are used for training one or more image/species/object identification models (e.g., shown as trained models 399 in FIG. 3C) on a machine learning system endpoint.

In some implementations, the user 301-a utilizes a user interface (UI) associated with the application 322-a to upload one or more images/photographs of one or more objects, further described in relation to FIG. 3B. The images/photographs may be directly uploaded to the cloud storage (e.g., cloud storage 307-a in FIG. 3B) by the user. In other cases, the at least one image/photograph of the at least one object is uploaded to the cloud storage via the API 312-a (or the container system 332-a). In some cases, the API 312-a (or the container system 332-a hosting the API 312-a) generates the pre-signed URL associated with the storage system, where the pre-signed URL is used to upload the image/photograph into the cloud storage. Further, the API 312-a generates identification metadata (also referred to as metadata) associated with the initial request, where the metadata is stored in one or more of the database 352-a and the cache 342-a, as shown by dataflows 305-e and 305-d, respectively. In some cases, the metadata associated with the initial request includes one or more of an image path (or file path) to the image/photograph in the cloud storage 307-A, geographical coordinates information (e.g., latitude and longitude information), user ID information, timestamp data, unique identifier for the identification batch, and a status. It should be noted that, this initial status (e.g., NO_IMAGE identified) may be changed over time as the system 300 proceeds with the image identification flow.

FIG. 3B illustrates an example of a system 300-b configured for identifying an object in a photograph, according to various aspects of the disclosure. The system 300-b implements one or more aspects of the systems described herein, including at least system 300-a. As seen, the system 300-b comprises a user device 304-b associated with a user 301-b, an application 322-b, an API 312-b, and a cloud storage 307-b. As noted above, a container system (e.g., shown as container system 332-a in FIG. 3A) may be used to deploy the API 312-b, where the API 312-b facilitates communication between the application 322-b and one or more external applications, computer programs, software, etc.

In some examples, the user 301-b uploads an image/photograph of an object (e.g., an animal, a plant, an insect, etc.) to the cloud storage 307-a via the application 322-b on the user device 304-b. Dataflow 305-g depicts the uploading of the photograph from the user device 304-b to the cloud storage 307-b. In some examples, uploading the object image is based in part on receiving the initial response (e.g., in dataflow 305-c) to the initial request (e.g., dataflows 305-a and 305-b in FIG. 3A), where the initial response is sent from the API 312 in response to the initial request received from the user device 304. In some cases, the cloud storage 307-b includes a plurality of folders, each folder associated with a pre-signed URL. The user device 304-b (or application 322-b) may directly upload the photograph to a folder (or a location) in the cloud storage 307-b using the pre-signed URL information (e.g., previously received from the API in dataflow 305-c). In some instances, the folder in the cloud storage 307-a may comprise one or more sub-folders, such as, but not limited to, a staging folder, a production folder, etc. The staging and production folders in the cloud storage 307-a may be separated to avoid “pollution”.

FIG. 3C illustrates an example of a system 300-c configured for identifying an object in a photograph, according to various aspects of the disclosure. The system 300-c implements one or more aspects of the systems described herein, including at least systems 300-a and 300-b. As seen, the system 300-c comprises a user device 304-c associated with a user 301-c, an application 322-c, an API 312-c, a machine learning platform 350, and a cloud storage 307-c, where the cloud storage includes a cache 342-b and a database 352-b. It is contemplated that, machine learning platform 350 may also be referred to as machine learning system endpoint 350, and the two terms may be used interchangeably throughout the disclosure. In some examples, the container system 332-b is used to deploy the API 312-c. Further, the API 312-c facilitates communication between the application 322-c and one or more external applications, computer programs, software, etc., as depicted by dataflows 305-i, 305-j, 305-k, 305-l, and 305-p. It should be noted that, one or more of these dataflows 305 may be optional.

The application 322-c may begin the process of image identification by sending the unique identifier for the identification batch to the container system 332-b and/or the API 312-c, as shown by dataflows 305-j. Next, the API 312-c updates the status of the identification batch from a first status (e.g., NO_IMAGE) to a second status (e.g., IDENTIFICATION_IN_PROGRESS) and stores this updated status information in the cache 342-b and/or the database 352-b of the cloud storage system 307-c. Dataflows 305-k and 305-l depict the API/container system updating the status information stored at the cache and database, respectively, of the cloud storage 307-c.

In some examples, the API/container system calls (e.g., via dataflow 305-i) the machine learning platform 350 with the image/photograph previously uploaded from the user device to the cloud storage. In one non-limiting example, the machine learning platform 350 receives the image of the object (e.g., from the cloud storage 307-c) in dataflow 305-n, based at least in part on the call from the API 312-c. The machine learning platform 350 also receives the identification metadata (or simply, metadata) stored in the cache 342-b via dataflow 305-m. In some cases, obtaining the photograph/image from the cloud storage 307-b comprises using the metadata at the API 312-c to locate the photograph on the cloud-based image storage system (i.e., cloud storage 307-b).

After receiving the metadata and the image, the machine learning platform 350 proceeds to perform image identification. In some cases, image identification may comprise using the photograph to invoke a first trained model (e.g., parent model 395) from the machine learning platform 350 (also referred to as machine learning system endpoint). The ML platform 350 comprises a plurality of trained models 399, including at least one parent model 395 and one or more child model(s) 396. It should be noted that, the parent model may be different from the child model(s), in some examples. Additionally, or alternatively, the parent model 395 and the one or more child models 396 may be stored on different ML platforms. In some examples, image identification comprises using the photograph to invoke a second trained model (e.g., one of child model 396-a, 396-b, or 396-c) from the machine learning platform 350. In some cases, the API 312-c invokes the first trained model, such as the parent model 396, using the photograph. Dataflow 305-i depicts the API 312-c invoking the trained model(s) 399 from the ML platform. In some examples, using the photograph to invoke the first trained model from the ML system endpoint further comprises using the parent model 396 to invoke a child model (e.g., child model 396-a) of the one or more child models 396. In some embodiments, the parent model 395 may be used to determine which child model of the plurality of child models 396 should be called for processing the image. The parent model invoked at the ML system endpoint/ML platform 350 may help identify a category (e.g., animal, plant, insect, to name a few non-limiting examples) associated with the object. Additionally, or alternatively, the child model may help identify at least one species (e.g., animal species, plant species, insect species, etc.) associated with the category associated with the object. In some examples, the child model may comprise one of a “plant” child model, a “mammal” child model, an “insect” child model, an “amphibian” child model, a “fish” child model, a “bird” child model, and a “tree bark” child model.

One or more of the user device 304-c, the application 322-c, the API 312-c, and the container system 332-b may be configured to obtain a list of one or more most likely identification probabilities associated with the object in the image/photograph from the second trained model (e.g., the child model). After receiving the list of the one or more most likely identification probabilities associated with the object, the application 322-c is configured to update the metadata associated with the object at the API 312-c via dataflow 305-i. The application 322-c (or another entity of the system 300-c) may also update the metadata stored at one or more of the API 312-c, the cache 342-b, and the database 352-b with the results of the image identification performed by the machine learning platform 350, the time it took to run said image identification, the machine learning system endpoints used, and/or the errors (if any).

In some instances, the application 322-c (or the container system 332-b, or API 312-c) is configured to update the status from the second status (e.g., identification in progress) to a third status (e.g., identification is complete, or identification failed) and store this updated status information at the cache 342-b and/or the database 352-b, as shown by dataflow 305-o.

FIG. 3D illustrates a diagrammatic representation of a system 300-d configured for identifying an object in a photograph, in accordance with one or more implementations. As seen, the system 300-d comprises a user device 304-d configured to run (or execute) an application 322-d, a container system 332-c, and an API 312-d. The API 312-d may be hosted on the container system 332-c, in some examples. In some cases, the communications between the one or more entities of the system 300-d are depicted as dataflows 305 (e.g., dataflows 305-q, 305-r, 305-s, 305-t, and 305-u). One or more of the dataflows 305 depicted in FIG. 3D may be optional. In some instances, the user device 304-d is associated with a user 301-d and is configured to display a UI associated with the application 322-d. In some examples, the application 322-d is configured to communicate with the container system 332-c (or the API 312-d), where the communication comprises exchange of data in the one or more dataflows 305. The API 312-d may be similar or substantially similar to one or more of the APIs 312 described herein, including at least API 312-a described in relation to FIG. 3A. Further, the container system 332-c is similar or substantially similar to the other container systems 332 described herein, including at least container system 332-a. One non-limiting example of the container system 332-c may include KUBERNETES, which is an open-source container orchestration system for automating software deployment, scaling, and management. Other types of container systems known in the art are contemplated in different embodiments and the examples listed herein are not intended to be limiting.

In some embodiments, the application 332-d polls the API 312-d at the container system 332-c at periodic intervals (e.g., every second, every 2 seconds, every 10 seconds, etc.), as shown by dataflow 305-q. The application 332-d may include hash information, such as, a pollhash (e.g., unique ID associated with the metadata or the identification batch), in the dataflow 305-q sent to the container system 332-c. In some cases, this polling process initiated with the container system 332-c may be used to request one or more of a status and image identification results from the API 312-d of the container system. The container system 332-c may transmit a response (shown as dataflow 305-r) to the application 322-d, where the response includes a status (e.g., identification in progress). The application and container system 332-c (or API 312-d) may send messages back and forth (e.g., dataflows 305-s, 305-t) until the application 322-d receives a response indicating the identification is complete. For example, the container system or API may transmit a response in the dataflow 305-t indicating that the image identification is complete. The response may optionally also include the list of results (i.e., the list of one or more most likely identification probabilities associated with the object). In some aspects, this back-and-forth messaging between the application and the container system/API allows queuing, throttling logic, and/or flow control to be built into the system 300-d. Additionally, the polling process described herein also allows the ML system endpoint (or ML platform) to scale, heal, and/or recover from any errors. Once the application 322-d receives the updated status (e.g., image identification is complete) and/or the list of the one or more most likely identification probabilities associated with the object from the API 312-d, it ceases sending the polling requests to identify the object in the photograph uploaded by the user 301-d from the user device 304-d.

FIG. 3E illustrates a diagrammatic representation of a system 300-e configured for identifying an object in a photograph, in accordance with one or more implementations. As seen, the system 300-e comprises a user device 304-e configured to run (or execute) an application 322-e, a container system 332-d, an API 312-e, a cache 342-c, and a database 352-c. The API 312-e may be hosted on the container system 332-d, in some examples. In some cases, the communications between the one or more entities of the system 300-e are depicted as dataflows 315 (e.g., dataflows 315-a, 315-b, 315-c, 315-d, 315-e, 315-f, 315-g, 315-h, and 305-i). One or more of the dataflows 315 depicted in FIG. 3E may be optional. In some instances, the user device 304-e is associated with a user 301-e and is configured to display a UI associated with the application 322-e. In some examples, the application 322-d communicates with the container system 332-c (or the API 312-e), where the communication comprises exchange of data in the one or more dataflows 315. The API 312-e may be similar or substantially similar to one or more of the APIs 312 described herein, including at least API 312-a described in relation to FIG. 3A. Further, the container system 332-d is similar or substantially similar to the other container systems 332 described herein, including at least container system 332-a. One non-limiting example of the container system 332-d may include KUBERNETES, which is an open-source container orchestration system for automating software deployment, scaling, and management. Other types of container systems known in the art are contemplated in different embodiments and the examples listed herein are not intended to be limiting.

In some examples, the list of one or more most likely identification probabilities associated with the object may comprise a list of objects. Further, the user 301-e may select an object from the list of objects displayed on the user device 304-e, i.e., after receiving the list of one or more most likely identification probabilities associated with the object. The selected object may comprise an object most similar to the object in the photograph previously uploaded by the user. Dataflow 315-b depicts this communication from the application/user device and the container system/API. The dataflow 315-b may include information about the selected object, a suggested object name for the object in the photograph, a hash value for the selected/suggested species, and an updated status (e.g., accepted or suggested status) for the identification batch. After receiving the dataflow 315-b, the API/container system proceeds to update the status for the identification batch to “accepted” or “suggested” and updates the metadata information stored in one or more of the cache 342-c and the database 352-c, as shown by dataflows 315-d and 315-e. Additionally, the API 312-e/the container system 332-d/application 322-e uses the updated metadata information, the hash value for selected/suggested species, the selected object, and/or the suggested object name to create a data file 333 (also referred to as a snap 333). The creation of the data file 333, shown by data flow 315-c, is based on one or more of the selected object and the suggested object name. In some cases, the data file 333 comprises one or more of an image of the object, geolocation information, and at least a portion of the metadata information associated with the object. In some instances, the information related to the data file or snap 333 is sent in dataflow 315-f and stored at the database 352-c. In some implementations, the application (or another entity of the system 300-e) associates and/or displays the data file 333 with a social media account associated with the user 301-e. In some circumstances, the database 352-c stores the information relating to the suggested object name (if any) provided by the user. This information may be used to refine future image identification results provided by the system 300-d.

After creating the snap/data file 333, the container system 332-d sends the data file associated with the object to the application 322-f in data flow 315-i.

FIGS. 5A-5E depict diagrammatic representations of system(s) 500 (e.g., system 500-a . . . e) configured for operating a machine learning system, according to various aspects of the disclosure. The system(s) 500 may be similar or substantially to the system(s) 100, including at least system 100-b, described above in relation to FIGS. 1A and 1B. Further, the system(s) 500 may implement one or more aspects of the computer system 400 described in relation to FIG. 4.

In some instances, the FIGS. 5A-5E depict a process flow for preparing training data, e.g., for training a machine learning model. In accordance with aspects of the disclosure, the training data may help a machine learning system endpoint (or machine learning platform), such as ML system endpoint 550 in FIG. 5C, to identify one or more objects in images/photographs (e.g., not previously seen or encountered by the ML system endpoint). The system(s) 500 implement one or more aspects of the system(s) 300, previously described in relation to FIGS. 3A-3E. Further, the system(s) 500 may have one or more similar or substantially components/elements as the system(s) 300, such as, but not limited to, a cloud storage system, one or more computing modules, and a ML system endpoint or ML platform.

FIG. 5A illustrates an example of a system 500-a configured for operating a machine learning system, according to various aspects of the disclosure. In some examples, the system 500-a is configured to receive human/user input from one or more users (shown as tagging team 510), herein referred to as “human-in-the-loop 577”. The user input may be received from one or more user devices associated with the one or more users. The system 500-a also utilizes a model training pipeline 599, described in further detail in the figures that follow FIG. 5A.

In some aspects, the illustrations in FIGS. 5A-5E also depict process flows associated with the operation of a ML system, where the ML system may be used for identifying an object in a photograph, in accordance with one or more implementations. As seen, FIG. 5A depicts one or more data flows 505 occurring between different components/elements of the system 500-a, where the data flows 505 represent the operations of the process flow. As seen, the system 500-a comprises a cloud storage system 507, a data versioning module 509, and one or more assets 511. In some circumstances, the elements of the system 500-a may be sorted into a first type, a second type, or a first and second type, based on whether they are associated with the human-in-the-loop 577 block or the model training pipeline 599 block. For example, the data versioning module 509 is associated with both the human-in-the-loop 577 block and the model training pipeline 599 block, while the tagging team 510 and assets 511 are only associated with the human-in-the-loop 577 (also referred to as HITL 577 for the sake of brevity).

As seen, the tagging team 510 may receive one or more new (e.g., previously unseen/untagged) images 525 in dataflow 505-a. The tagging team 510 may periodically upsert data associated with the images 525 to the cloud storage 507. The cloud storage 507 may be similar or substantially similar to the cloud storage 307 previously described in relation to FIGS. 3A-E. The cloud storage 507 may store image related data (e.g., images of plants, animals, insects, tree barks, amphibians, fish, etc.), tags or labels for one or more images of one or more species, and any other applicable data. As used herein, the term “upsert” may refer to a computing operation that inserts data in a data structure, such as a database table. In some examples, the data may be inserted as rows in a database table (e.g., if said data does not already exist). Alternatively, upserting data may comprise modifying or updating previously stored data in the database table or another applicable data structure. In one non-limiting example, the cloud storage 507 may comprise Amazon Simple Storage Service (or Amazon S3), which utilizes “buckets” or containers for storing data (e.g., objects). Other types of cloud storage systems known in the art are contemplated in different embodiments and the examples listed herein are not intended to be limiting. In some examples, the tagging team 510 may tag/place labels on the images 525, where the label comprises a species name (e.g., Silverback Gorilla, Mango Tree, Giant Sequoia, Mosquito, Bluefin Tuna, etc.) and any other applicable information. In some examples, the tagging team 510 may tag at least 100 images per species, although this is not intended to be limiting. In some instances, less than 100 images may be received for a species. In such cases, less than 100 labels/tags may be received for that species. In yet other cases, if the number of images received for a species is very high (e.g., >5,000, >10,000, etc.), the tagging team 510 may only tag/label a sub-set of the images 525 for that species. In either case, after tagging/labeling the images 525, the tagging team 510 (e.g., via one or more user devices) uploads the data to the cloud storage 507, shown by data flow 505-b. This data may be inserted into one or more folders on the cloud storage, where each of the one or more folders may include a folder name. While not necessary, in some embodiments, the folder name for each folder may be based on the species name/tag/label assigned by the users/tagging team 510.

In some cases, the data versioning module 509 is configured to receive the data (i.e., provided by the users 510 and stored in the cloud storage 507) in data flow 505-c. The data versioning module 509 may be configured to prepare metadata for the images 525 based on the data received in the cloud storage 507 (e.g., in the cloud storage bucket, such as, but not limited to, a S3 bucket). This metadata may be used for additional preprocessing by the system 500, described in further detail below. In some examples, the data versioning module 509 creates a versioning snapshot of the metadata associated with the images 525, the data in the cloud storage 507, or both. Further, the versioning module 509 may apply quality assurance (QA) on the versioning snapshot, the metadata associated with the images, and/or the data in the cloud storage 508. In some examples, the versioning module 509 (or another module of the system 500-a) may output one or more reports, based on the QA. The one or more reports 545 may contain information pertaining to any warnings and errors detected by the system 500-a in the versioning snapshot and/or any other applicable data associated with the images 525. Following QA, the versioning module 509 sends the versioning snapshot, the one or more reports 545, including warnings and errors (if any), metadata associated with the images, tagging/labeling information provided by the tagging team 510, and/or any other applicable data associated with the images 525, to assets 511 in data flow 505-d. In one non-limiting example, the assets 511 may comprise a cloud-based storage system, local storage, CPU memory (e.g., RAM, ROM), DRAM, SRAM, a local file or directory, or any other applicable storage system. Further, the data (e.g., received in data flow 505-d) may be stored in a database table, a comma separated value (CSV) format, a JavaScript Object Notation (JSON) format, or any other applicable file storage format.

In some cases, the data versioning module also sends the one or more reports 545 (associated with the QA operation), including any warnings and/or errors detected by the data versioning module 509, to the tagging team 510.

As noted above, the data versioning module 509 may be part of the human-in-the-loop (HITL) 577 and the model training pipeline 599 and may serve as a connection/handover point between these two sub-divisions of the system 500. In some examples, the data versioning module 509 (or simply versioning module 509) communicates with other components/elements of the system(s) 500 shown in FIGS. 5B-5D, including at least the cloud storage 507. As seen, the data versioning module 509 transmits the metadata information associated with the images 525, including at least a URI and a label for each of the images 525, to the cloud storage 507 in dataflow 505-e.

Turning now to FIG. 5B, which illustrates an example of a system 500-b configured for operating a machine learning system, according to various aspects of the disclosure. Broadly, the illustration in FIG. 5B depicts the model training pipeline 599 segment of the system 500. In some examples, the cloud storage 507 stores one or more of the images 525 and images metadata (e.g., URL, label or tags, and any other applicable information associated with the images 525) after receiving them via dataflow 505-e. The cloud storage 507 may be at least one of electronically, logistically, and/or communicatively coupled to the ML system endpoint 550. The ML system endpoint 550 may be similar or substantially similar to the ML platform 350 described above. The ML system endpoint 550 may be configured to preprocess the data received from the cloud storage 507 in dataflow 505-f, where the data may include the images metadata and/or the images 525. The ML system endpoint 550 comprises one or more computing modules, such as resampling module 501, preprocessing module 521, reporting module 531, and record merge module 541. These computing modules may be similar or substantially to the computing modules described in relation to FIGS. 1A and 1B and may be embodied in hardware, software, or a combination thereof. Further, the various modules of the ML system endpoint 550 may communicate with each other (shown as dataflows 505-g, 505-h, 505-i). After receiving the data in dataflow 505-f, the resampling module 501 resamples the images per category (e.g., parent model) and relays the information generated from the resampling operation to the preprocessing module 521 in dataflow 505-g.

The preprocessing module 521 is configured to preprocess the plurality of datafiles received in dataflows 505-f and/or 505-g, where the datafiles include one or more of the images and the images metadata (e.g., URI, labels or tags, species name, path to the data in the cloud storage, etc.). Preprocessing may comprise (1) splitting the plurality of datafiles into a training data set, a test data set, and/or a validation data set, and (2) writing or creating record IO files (e.g., by using the “im2rec.cc” tool for creating a RecordIO dataset). In one non-limiting example, the training data set comprises ˜80% of the data files/images and each of the testing data set and the validation data set comprise ˜10% of the data files/images. In some cases, the preprocessing module 521 helps prepare images for model training by (1) converting the image data to features, and (2) issuing a plurality of data sets, each data set having a plurality of images. In some examples, RecordIO refers to a data format originally built on the MXNet framework that may be utilized for storing a plurality of images in a single file (e.g., by making each image a record). RecordIO implements a file format for a sequence of records, where the images are stored as records and packed together. In some aspects, RecordIO enables images to be stored in a compact format (e.g., JPEG), for records, which helps reduce the size of the dataset. Further, packing the images/data together allows for continuous or substantially continuous reading on the disk or storage, which enhances speed while accessing data. In some cases, RecordIO also enables images/data files to be placed in different partitions in a distributed setting. As such, RecordIO facilitates in creating datasets that may be used for training, testing, and/or validating ML models. In some cases, the preprocessing module 521 creates a plurality of RecordIO data files comprising a plurality of training set RecordIO files, a plurality of testing set RecordIO files, a plurality of validation set RecordIO files, and a plurality of full set RecordIO files. The preprocessing module 521 (or another module of the system 500-b, such as record merge module 541) merges the plurality of RecordIO files for each set (i.e., training, testing, validation, and full data sets) and passes the merged RecordIO files to the storage device 507 in dataflow 505-j.

In some cases, the reporting module 531 is configured to generate one or more reports based on the data received from the preprocessing module 521 in dataflow 505-h. The one or more reports generated by the reporting module 531 may include an average image count per class/category, total class count, image count for each of the training, validation, and testing data sets, information pertaining to corrupted images (if any), etc. In some examples, the corrupt image information may include metadata information, file name or record name, file/image path, URI, label or tagging information, etc., for each of the one or more corrupt images.

The cloud storage 507 is configured to store one or more of the plurality of data files comprising the images and metadata information, the training/test/validation/full data sets, and the RecordIO files associated with each of the datasets, received via dataflow 505-j. The cloud storage 507 may be in communication with the hyperparameter tuning module 523 and the tuning module 537, as shown by dataflows 505-k and 505-n, respectively. The hyperparameter tuning module 523 is configured to run/execute a plurality of model training jobs, each producing a model version. In some cases, the hyperparameter tuning module 523 receives the sampled trained and validation data (in data flow 505-k) from the respective merged RecordIO file(s), where the sampled trained and validation data comprises, the images deemed to optimize the model training. In some cases, the hyperparameter tuning module 523 receives a sample (i.e., rather than the entire training and validation data sets) based on the size/number of images in the data sets. For example, the hyperparameter tuning module 523 may receive at least a portion of the data set if the size of the data set(s) exceed a pre-defined threshold (e.g., >30,000 images; >10,000 images; >50,000 images, to name a few). As an example, if the threshold number of images for sampling is 30,000 images and there are more than 30,000 images, the cloud storage 507 samples 30,000 images (i.e., from the training and validation data sets) and passes them to the hyperparameter tuning module 523. The hyperparameter tuning module 523 (or simply, tuning module 523) applies different hyperparameters on the training and validation data sets across a number of model training jobs, where each job outputs parameters. Some non-limiting examples of hyperparameters include learning rate and batch size.

In some examples, the system 500-b (or another module of the systems 100 and/or 500) assess the different model versions generated by the hyperparameter tuning module 523 to determine the most optimal or accurate model version for training the merged full set RecordIO files (e.g., received in data flow 505-k). As seen, the system 500-b further includes one or more of model metrics 527, model artifacts 529, and optimal model parameters 533. In some cases, the model metrics 527 may be visualized in the ML system endpoint 550 and the optimal model parameters 533 may be associated with (e.g., stored in, determined at, etc.) the ML system endpoint 550. One non-limiting example of the ML system endpoint 550 includes SAGEMAKER provided by AMAZON, INC., of Seattle, Wash. The model metrics 527, model artifacts 529, and optimal model parameters 533 may be in communication with the hyperparameter tuning module 523 via dataflow 505-l. The model matric 527 facilitates in visualization of the one or more model versions generated by the hyperparameter tuning module 523, which may be used to determine the best/optimal model parameters 533. The tuning module 537 receives the optimal model parameters 533 information in dataflow 505-m and the full training dataset from the cloud storage 507 in dataflow 505-n, which are then used for further analysis and/or training a model on the full dataset.

FIG. 5C shows another example of a system 500-c configured for operating a machine learning system, according to various aspects of the disclosure. Similar to FIG. 5B, the illustration in FIG. 5C depicts the model training pipeline 599 segment of the system 500. As seen in FIG. 5C, the training module 537 passes an output (in dataflow 505-o) to one or more of the model metrics 527 and the model artifacts 529. Specifically, the training module 537 passes the resulting model artifacts and their metrics for storage in the cloud storage 507. In some cases, an evaluation repot generating module 539 receives the model artifacts 529 and model metrics 527 information in dataflow 505-p and generates a report, where the report includes the model metrics for a model that was trained on the full data set (e.g., received by the training module 537 in dataflow 505-n). The evaluation report issued by the module 539 includes the model metrics 527 (e.g., the percentage of images correctly identified by each of the one or more models). The ML system endpoint uses the information related to the model metrics 527 to determine which model/model version to run for a particular job. In some examples, the system 500-c also produces model artifacts 529, which are examples of assets of the model and used to reproduce the training model. The evaluation report generating module 539 is configured to store this evaluation report to the cloud storage 507, as depicted by dataflow 505-q. In some examples, the evaluation report generating module 539 also receives the test data set 556 and/or the validation data set 566 from the cloud storage 507, which may also be used to generate the evaluation report. The cloud storage 507 comprises a reports folder 543 for storing the one or more evaluation reports 545 received from the evaluation report generating module 539. In some cases, the cloud storage 507 (e.g., S3) also stores one or more of the model artifacts 529 and the model metrics 527, where the model artifacts and/or the model metrics may be used to train a model on the full data set (or at least a portion of the full data set, e.g., if the full data set comprises corrupted data, the corrupted data may not be used to train the model).

In some cases, training the model on at least a portion (or all) of the full data set comprises training the model using the best/most optimal model parameters 533. In some cases, a final model is created based at least in part on creating the full training model (i.e., a model created using a majority or all of the training data set), the model artifacts 529, and the model metrics 527.

Turning now to FIG. 5D, which illustrates an example of a system 500-d configured for operating a machine learning system, according to various aspects of the disclosure. The illustration in FIG. 5D depicts the model training pipeline 599 segment, a model deployment system 555, a model monitoring system 569, and a triggers/rules 581 block. As seen, the system 500-d includes the training module 537 (previously described in relation to FIGS. 5B and 5C), where the training module 537 receives the full training data set/full set RecordIO files (dataflows 505-n), the test and validation data sets 556, 566, and the optimal model parameters 505-m. The training module 537 passes the information generated from the training step to the model packaging module 547 in dataflow 505-r. As noted above, the training step/operation comprises creating a full training model, where creating the full training model comprises training a model on the full data set (or full set RecordIO files) based at least in part on receiving the optimal model parameters 533 (shown in FIG. 5B), the full set RecordIO files, and one or more of the model artifacts 529 and the model metrics 527. Thus, the dataflow 505-r may include the full training model created by the training module 537. The model packaging module 547 (or the training module 537) creates a final model, where the final model is created based upon creating the full training model. In some cases, creating the final model comprises wrapping the full training model, model artifacts 529, and model metrics 527. It is contemplated that, the term “final model” may also be referred to as a “wrapped model” and the two terms may be used interchangeably throughout the disclosure. This wrapped/final model is then passed to the model registry 549, further described below.

In some embodiments, the model packaging module 547 receives the output (data flow 505-r) from the training module 537 and creates a model package that is registered in a model registry 549. Dataflow 505-s depicts the registration of the model package in the model registry 549 by the model packaging module 547. One non-limiting example of a model registry 549 comprises the SageMaker Model Registry (also referred to as SM Model Registry) provided by AMAZON, INC., of Seattle, Wash. Other types of model registries known in the art are contemplated in different embodiments and the examples listed herein are not intended to be limiting.

In some embodiments, the model deployment system 555 comprises a trained model 51 and the ML system endpoint 550. The model deployment system 555 is one of electronically, logistically, and communicatively coupled to the model registry 549 and receives the registered and final/approved model version from the model registry via dataflow 505-t. This final/approved version is stored at the model deployment system 555 as the trained model 551 and deployed 573 at the ML system endpoint 550. In some cases, deploying the trained model 551 comprises executing the trained model 551 at the ML system endpoint 550.

In some embodiments, the model registry 549 also passes a message (e.g., approved message 575) to the triggers/rules 581 segment of the system 500-d, where the approved message 575 includes one or more of the final/approved model version, information associated with the final/approved version, and any other applicable information. In some examples, the triggers/rules 581 includes rules 553 and/or the tagging team 510. Alternatively, the triggers/rules 581 receives human/user input from the tagging team 510. The rules 553 may be used to define triggers or rules for pipeline launch (e.g., model training pipeline 599), model deployment, etc. In this example, the model deployment system 555 receives an instruction for triggering/scheduling launch 574 from the triggers/rules 581 segment of the system 500-d. Upon receiving this launch 574 instruction, the model deployment system 555 deploys the trained model 551 at the ML system endpoint 550, which in turn enables the ML system endpoint to capture data. The ML system endpoint 550 transmits one or more requests, image identification predictions, etc., to the cloud storage 507 via dataflow 505-u.

In some examples, the cloud storage 507 in FIG. 5D stores the information associated with the requests, predictions, etc., received from the ML system endpoint 550 and relays at least a part of this information to the customized monitoring module 562 of the model monitoring system 569. The customized monitoring module 562 communicates with the cloud storage 507 via dataflow 505-v, the baseline stats and constraints module 561 via dataflow 505-w, the results module 563 via dataflow 505-x, and the cloud metrics module 563 via dataflow 505-y. The model monitoring system 569 is configured to continuously monitor the quality of the trained ML models (e.g., trained model 551, which may be a parent model or a child model) generated by the model packaging module 547 and deployed at the ML system endpoint 550. In some cases, the customized monitoring module 562 receives baseline statistics and constraints information, which is used as a minimum benchmark (or baseline) for assessing the quality/performance/efficacy of the trained model 551. While not necessary, in some cases, the baseline stats and constraints may be calculated from the training data set. Further, the baseline statistics used to assess the quality of the trained model 551 may be based on image information. As an example, the customized monitoring module 562 transmits an alert if the cloud storage 507 provides a single-color image (e.g., image is entirely white, entirely black, etc.), provides a corrupted image, or provides an image that is not in the training data set (or the training set RecordIO files).

In some examples, the customized monitoring module 562 (or alternatively, the results module 563) generates the relevant results, statistics, and violations (if any) based on comparing one or more qualitative metrics of the trained model 551 with respect to the baseline. The results module 563 stores the information related to the results, statistics, and violations for further refining and fine-tuning the models generated by the system(s) 500. The model monitoring system 569 may also utilize a monitoring service, provided by way of the cloud metrics module 563, for monitoring cloud storage resources. In one non-limiting example, the cloud metrics module 563 comprises AMAZON CLOUDWATCH provided by AMAZON, INC., of Seattle, Wash. Amazon CloudWatch refers to a monitoring service for Amazon Web Services (AWS) cloud resources. In this example, the cloud metrics module is integrated with the model monitoring system 569. In some embodiments, the model monitoring system 569 also receives information related to schedules/launches 576 from the triggers/rules 581 segment of the system 500-d, where the schedule/launch 576 information includes . . . . In some embodiments, the triggers/scheduling may be manual (e.g., based on human/user input from the tagging team 510) or automated (e.g., based on the rules 553).

FIG. 4 illustrates a diagrammatic representation of one embodiment of a computer system 400, within which a set of instructions can execute for causing a device to perform or execute any one or more of the aspects and/or methodologies of the present disclosure. The components in FIG. 4 are examples only and do not limit the scope of use or functionality of any hardware, software, firmware, embedded logic component, or a combination of two or more such components implementing particular embodiments of this disclosure. Some or all of the illustrated components can be part of the computer system 400. For instance, the computer system 400 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 400 includes at least a processor 401 such as a central processing unit (CPU) or a graphics processing unit (GPU) to name two non-limiting examples. Any of the subsystems described throughout this disclosure could embody the processor 401. The computer system 400 may also comprise a memory 403 and a storage 408, both communicating with each other, and with other components, via a bus 4100. The bus 4100 may also link a display 432, one or more input devices 433 (which may, for example, include a keypad, a keyboard, a mouse, a stylus, etc.), one or more output devices 434, one or more storage devices 435, and various non-transitory, tangible computer-readable storage media 436 with each other and/or with one or more of the processor 401, the memory 403, and the storage 408. All of these elements may interface directly or via one or more interfaces or adaptors to the bus 4100. For instance, the various non-transitory, tangible computer-readable storage media 436 can interface with the bus 4100 via storage medium interface 426. Computer system 400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 401 (or central processing unit(s) (CPU(s))) optionally contains a cache memory unit 432 for temporary local storage of instructions, data, or computer addresses. Processor(s) 401 are configured to assist in execution of computer-readable instructions stored on at least one non-transitory, tangible computer-readable storage medium. Computer system 400 may provide functionality as a result of the processor(s) 401 executing software embodied in one or more non-transitory, tangible computer-readable storage media, such as memory 403, storage 408, storage devices 435, and/or storage medium 436 (e.g., read only memory (ROM)). Memory 403 may read the software from one or more other non-transitory, tangible computer-readable storage media (such as mass storage device(s) 435, 436) or from one or more other sources through a suitable interface, such as network interface 420. Any of the subsystems herein disclosed could include a network interface such as the network interface 420. The software may cause processor(s) 401 to carry out one or more processes or one or more steps of one or more processes described or illustrated herein. Carrying out such processes or steps may include defining data structures stored in memory 403 and modifying the data structures as directed by the software. In some embodiments, an FPGA can store instructions for carrying out functionality as described in this disclosure. In other embodiments, firmware includes instructions for carrying out functionality as described in this disclosure.

The memory 403 may include various components (e.g., non-transitory, tangible computer-readable storage media) including, but not limited to, a random-access memory component (e.g., RAM 404) (e.g., a static RAM “SRAM”, a dynamic RAM “DRAM, etc.), a read-only component (e.g., ROM 404), and any combinations thereof. ROM 404 may act to communicate data and instructions unidirectionally to processor(s) 401, and RAM 404 may act to communicate data and instructions bidirectionally with processor(s) 401. ROM 404 and RAM 404 may include any suitable non-transitory, tangible computer-readable storage media. In some instances, ROM 404 and RAM 404 include non-transitory, tangible computer-readable storage media for carrying out a method, such as method 200 described in relation to FIG. 2. In one example, a basic input/output system 406 (BIOS), including basic routines that help to transfer information between elements within computer system 400, such as during start-up, may be stored in the memory 403.

Fixed storage 408 is connected bi-directionally to processor(s) 401, optionally through storage control unit 407. Fixed storage 408 provides additional data storage capacity and may also include any suitable non-transitory, tangible computer-readable media described herein. Storage 408 may be used to store operating system 404, EXECs 410 (executables), data 411, API applications 412 (application programs), and the like. Often, although not always, storage 408 is a secondary storage medium (such as a hard disk) that is slower than primary storage (e.g., memory 403). Storage 408 can also include an optical disk drive, a solid-state memory device (e.g., flash-based systems), or a combination of any of the above. Information in storage 408 may, in appropriate cases, be incorporated as virtual memory in memory 403.

In one example, storage device(s) 435 may be removably interfaced with computer system 400 (e.g., via an external port connector (not shown)) via a storage device interface 425. Particularly, storage device(s) 435 and an associated machine-readable medium may provide nonvolatile and/or volatile storage of machine-readable instructions, data structures, program modules, and/or other data for the computer system 400. In one example, software may reside, completely or partially, within a machine-readable medium on storage device(s) 435. In another example, software may reside, completely or partially, within processor(s) 401.

Bus 440 connects a wide variety of subsystems. Herein, reference to a bus may encompass one or more digital signal lines serving a common function, where appropriate. Bus 440 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 400 may also include an input device 433. In one example, a user of computer system 400 may enter commands and/or other information into computer system 400 via input device(s) 433. Examples of an input device(s) 433 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 433 may be interfaced to bus 440 via any of a variety of input interfaces 423 (e.g., input interface 423) including, but not limited to, serial, parallel, game port, USB, FIREWIRE, THUNDERBOLT, or any combination of the above.

In particular embodiments, when computer system 400 is connected to network 430, computer system 400 may communicate with other devices, such as mobile devices and enterprise systems, connected to network 430. Communications to and from computer system 400 may be sent through network interface 420. For example, network interface 420 may receive incoming communications (such as requests or responses from other devices) in the form of one or more packets (such as Internet Protocol (IP) packets) from network 430, and computer system 400 may store the incoming communications in memory 403 for processing. Computer system 400 may similarly store outgoing communications (such as requests or responses to other devices) in the form of one or more packets in memory 403 and communicated to network 430 from network interface 420. Processor(s) 401 may access these communication packets stored in memory 403 for processing.

Examples of the network interface 420 include, but are not limited to, a network interface card, a modem, and any combination thereof. Examples of a network 430 or network segment 430 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 430, may employ a wired and/or a wireless mode of communication. In general, any network topology may be used.

Information and data can be displayed through a display 432. Examples of a display 432 include, but are not limited to, a liquid crystal display (LCD), an organic liquid crystal display (OLED), a cathode ray tube (CRT), a plasma display, and any combinations thereof. The display 432 can interface to the processor(s) 401, memory 403, and fixed storage 408, as well as other devices, such as input device(s) 433, via the bus 440. The display 432 is linked to the bus 440 via a video interface 422, and transport of data between the display 432 and the bus 440 can be controlled via the graphics control 421.

In addition to a display 432, computer system 400 may include one or more other peripheral output devices 434 including, but not limited to, an audio speaker, a printer, and any combinations thereof. Such peripheral output devices may be connected to the bus 440 via an output interface 424. Examples of an output interface 424 include, but are not limited to, a serial port, a parallel connection, a USB port, a FIREWIRE port, a THUNDERBOLT port, and any combinations thereof.

In addition, or as an alternative, computer system 400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein, including at least operations 202 through 212 of method 200 in FIG. 2, may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 400 shown in FIG. 4 such as, but not limited to, the network 430, processor 401, memory, 403, etc., may comprise a cloud computing system. In one such system, front-end systems such as input devices 433 may provide information to back-end platforms such as servers (e.g., computer systems 400) and storage (e.g., memory 403). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method of operating a machine-learning system, the method comprising:
preparing a plurality of data files for training by associating a label with each of the plurality of data files, identifying and fixing errors in the plurality of data files, and uploading the plurality of data files to a storage device;
obtaining a versioning snapshot of the plurality of data files uploaded to a storage device;
providing metadata associated with the plurality of data files to the machine-learning system;
splitting the plurality of data files into a plurality of data sets, including at least a training data set, a testing data set, and a validation data set;
creating record IO data files comprising a plurality of training set record IO files, a plurality of testing set record IO files, a plurality of validation set record IO files, and a plurality of full set record IO files;
merging the plurality of record IO files for each data set of the plurality of data sets;
passing the merged record IO files to the storage device;
identifying hyperparameter settings for use in association with training the merged full set record IO files by (1) selecting a portion of the merged testing IO files and a portion of the merged validation IO files, (2) applying a plurality of hyperparameters to the selected portion of the merged testing IO files and the selected portion of the merged validation IO files across a plurality of training jobs, and (3) reviewing one or more metrics related to the plurality of training jobs;
storing artifacts related to the plurality of training jobs at the storage device;
using the identified hyperparameter settings and the artifacts to train the merged full set record IO files;
storing one or more metrics and artifacts associated with training the merged full set record IO files;
using the one or more metrics and artifacts associated with training the merged full set record IO files to create a final machine learning model;
obtaining the final machine learning model from a machine learning system registry; and
deploying the final machine learning model to one or more machine learning system endpoints.

2. The method of claim 1, wherein the label comprises one of a predetermined category and a species associated with one of the predetermined categories;
wherein, when the label comprises a predetermined category, the final machine learning model comprises a first trained model and the first trained model comprises a parent model;
wherein, when the label comprises, a species associated with one of the predetermined categories, the final machine learning model comprises a second trained model and the second trained model comprises a child model;
the method further comprising:
when the label comprises a predetermined category, identifying the predetermined categories associated with the plurality of data files;
when the label comprises a predetermined category, training the machine-learning system on the same number of data files for each identified category;
wherein the identifying the predetermined categories associated with the plurality of data files and the training the machine-learning system on the same number of data files for each identified category occurs after providing metadata associated with the plurality of data files to the machine-learning system and before splitting the plurality of data files into the training data set, the testing data set, and the validation data set.

3. The method of claim 1, wherein the predetermined categories comprise eight categories;
wherein the eight categories comprise or are otherwise associated with plants, mammals, insects, amphibians, fish, birds, tree bark, and snails; and
wherein the species comprise one of a plant species, a mammal species, an insect species, an amphibian species, a fish species, a bird species, a tree bark species, and a snail species.

4. The method of claim 1, wherein the plurality of data files uploaded to the storage device comprises images of at least one of a plurality of the predetermined categories, and the species associated with one of the predetermined categories;
wherein the storage device comprises a cloud-based storage system;
wherein uploading the plurality of data files to a storage device comprises uploading the plurality of data files to a folder on the cloud-based storage system;
wherein the folder on the cloud-based storage system comprises a folder name;
wherein the folder name comprises the label;
wherein an output of the training jobs comprises identification information related to an object in the images; and
wherein the one or more metrics comprises a percentage of the identification information which accurately identifies the object in the images.

5. The method of claim 4, wherein, when the plurality of data files uploaded to the storage device comprise images of a plurality of the predetermined categories, the plurality of data files comprise at least 100 images for each of the plurality of predetermined categories included in the plurality of data files;
wherein training the machine-learning system on the same number of data files for each category comprises:
determining a fewest number of data files associated with a single predetermined category across all predetermined categories identified in the plurality of data files,
for all predetermined categories identified in the plurality of data files having a number of data files greater than the fewest number of data files, randomly selecting an amount of data files to equal the fewest number of data files, and
training the machine-learning system on the fewest number of data files associated with the single predetermined category, and the randomly selected data files for each of the predetermined categories identified as having a number of data files greater than the fewest number; and
wherein the artifacts comprise assets to reproduce the model.

6. The method of claim 5, wherein using the fewest number of data files across all predetermined categories identified in the plurality of data files to train the machine-learning system comprises decreasing a bias in the machine learning system towards any particular category of the identified categories; and
wherein the one or more metrics are reviewed with a machine learning system report.

7. The method of claim 4, wherein identifying and fixing errors in the plurality of data files comprises identifying and fixing mismatches in the plurality of data files;
wherein the metadata comprises the label and a uniform resource identifier;
wherein the training data set comprises 80% of the plurality of data files, the testing data set comprises 10% of the plurality of data files, the validation data set comprises 10% of the plurality of data files, and a full data set comprises 100% of the plurality of data files; and
after creating record IO data files, reporting information about each data set, wherein the information about each data set comprises one or more of a JavaScript Object Notation (JSON) file, a total image count in each data set, and a corrupted images count in each data set.

8. A method of identifying an object in a photograph, the method comprising:
sending an initial request to identify the object in the photograph from a user device to an application programming interface (API);
generating, at the API, a pre-signed Uniform Resource Locator (URL) associated with a storage system;
generating metadata associated with the initial request;
sending an initial response to the initial request;
uploading the photograph from a user device directly to a location associated with the pre-signed URL;
sending a second request to identify the object in the photograph from the user device to the API;
providing a second response to the second request;
obtaining the photograph from the storage system;
using the photograph to invoke a first trained model from a machine learning system endpoint;
using the photograph to invoke a second trained model from the machine learning system endpoint;
obtaining from the second trained model a list of one or more most likely identification probabilities associated with the object;
updating the metadata associated with the object at the API;
sending a third request from the user device to the API, wherein the third request comprises a request to receive information associated with the list of one or more most likely identification probabilities; and
displaying at the user device one or more of the list of one or more most likely identification probabilities associated with the object, and information associated with the one or more of the list of one or more most likely identification probabilities associated with the object.

9. The method of claim 8, wherein the initial response comprises one of a response comprising the pre-signed URL and at least a portion of the metadata, or a response denying the request;
wherein the storage system comprises a cloud-based image storage system;
wherein the metadata comprises one or more of an image path, geographic location information associated with the photograph, user identification information, timing information, and a status of the request;
wherein the second request includes at least a portion of the metadata;
wherein the second response informs the user device from the API that the image is being processed;
obtaining the photograph from the storage system comprises using the metadata at the API to locate the photograph on the cloud-based image storage system;
wherein using the photograph to invoke a first trained model from a machine learning system endpoint comprises invoking the first trained model by the API;
wherein the first trained model comprises a parent model;
wherein the second trained model comprises a child model; and
wherein using the photograph to invoke the second trained model from the machine learning system endpoint comprises using the parent model to invoke the child model.

10. The method of claim 9, wherein the response denying the request is provided when at least one of the API fails to identify at least one photograph due to an account setting associated with the photograph preventing identifying the photograph, and a security setting preventing identifying the photograph;
wherein the image path comprises a data string identifying a location where the photograph is stored;
wherein the user identification information comprises one or more of a data string associated with a user, a timestamp, and a data string associated with the request;
wherein the status of the request comprises a first status, a second status, a third status, and a fourth status;
wherein the cloud-based image storage system comprises Amazon Simple Storage Service (S3);
wherein at least one of the metadata and the photograph are located in a cache associated with the cloud-based image storage system;
wherein the parent model identifies a category associated with the object;
wherein the child model identifies at least one species associated with the category associated with the object;
wherein the list of one or more most likely identification probabilities is not received when the machine learning system endpoint is unavailable; and
wherein updating the metadata associated with the object comprises:
changing a status of the request to the third status,
providing a period of time associated with the period between sending the initial request to identify the object in the photograph and invoking the first trained model from the machine learning system endpoint, and
providing a period of time associated with the period between sending the initial request to identify the object in the photograph and invoking the second trained model from the machine learning system endpoint.

11. The method of claim 10, wherein the account setting comprises a non-premium user account;
wherein the first status identifies that the object has not been identified in the photograph and is set after the initial request;
wherein the second status identifies that identification of the object in the photograph is in progress, and is set after the second request;
wherein the third status comprises one of identification of the object is complete after receiving the list of one or more most likely identification probabilities and identification of the object is failed when the list of one or more most likely identification probabilities is not received;
wherein the fourth status comprises an accepted status when the object is selected and a suggested status when the object name is suggested; and
wherein the child model comprises one of a plant child model, a mammal child model, an insect child model, an amphibian child model, a fish child model, a bird child model, and a tree bark child model.

12. The method of claim 8, wherein the sending the second request to identify the object in the photograph from the user device to the API comprises sending a plurality of second requests to identify the object in the photograph from the user device to the API;
wherein each of the plurality of second requests to identify the object in the photograph after a first of the plurality of second requests to identify the object in the photograph is sent at a predetermined period of time after the prior of the plurality of second requests to identify the object in the photograph,
and further comprising;
ceasing sending the plurality of second requests to identify the object in the photograph when the list of one or more most likely identification probabilities associated with the object is obtained.

13. The method of claim 12, wherein the plurality of second requests to identify the object in the photograph from the user device to the API comprises a polling operation and hash information related to the metadata; and
wherein the predetermined period of time comprises a two second interval.

14. The method of claim 8, wherein the list of one or more most likely identification probabilities associated with the object comprises the information associated with the list of one or more most likely identification probabilities, and a list of species; and
wherein the information associated with the list of one or more most likely identification probabilities comprises an object name for each of the most likely identification probabilities, an object description for each of the most likely identification probabilities, a hash value associated with each of the most likely identification probabilities, and a photograph for each of the most likely identification probabilities; and
wherein the list of species includes a hash value associated with the species.

15. A non-transient computer-readable storage medium having instructions embodied thereon, the instructions being executable by one or more processors to perform a method for operating a machine-learning system, the method comprising:
preparing a plurality of data files for training by associating a label with each of the plurality of data files, identifying and fixing errors in the plurality of data files, and uploading the plurality of data files to a storage device;
obtaining a versioning snapshot of the plurality of data files uploaded to a storage device;
providing metadata associated with the plurality of data files to the machine-learning system;
splitting the plurality of data files into a plurality of data sets, including at least a training data set, a testing data set, and a validation data set;
creating record IO data files comprising a plurality of training set record IO files, a plurality of testing set record IO files, a plurality of validation set record IO files, and a plurality of full set record IO files;
merging the plurality of record IO files for each data set of the plurality of data sets;
passing the merged record IO files to the storage device;
identifying hyperparameter settings for use in association with training the merged full set record IO files by (1) selecting a portion of the merged testing IO files and a portion of the merged validation IO files, (2) applying a plurality of hyperparameters to the selected portion of the merged testing IO files and the selected portion of the merged validation IO files across a plurality of training jobs, and (3) reviewing one or more metrics related to the plurality of training jobs;
storing artifacts related to the plurality of training jobs at the storage device;
using the identified hyperparameter settings and the artifacts to train the merged full set record IO files;
storing one or more metrics and artifacts associated with training the merged full set record IO files;
using the one or more metrics and artifacts associated with training the merged full set record IO files to create a final machine learning model;
obtaining the final machine learning model from a machine learning system registry; and
deploying the final machine learning model to one or more machine learning system endpoints.

16. The computer-readable storage medium of claim 15, wherein the label comprises one of a predetermined category and a species associated with one of the predetermined categories;
wherein, when the label comprises a predetermined category, the final machine learning model comprises a first trained model and the first trained model comprises a parent model;
wherein, when the label comprises a species associated with one of the predetermined categories, the final machine learning model comprises a second trained model and the second trained model comprises a child model;
the method further comprising:
when the label comprises a predetermined category, identifying the predetermined categories associated with the plurality of data files;
when the label comprises a predetermined category, training the machine-learning system on the same number of data files for each identified category;
wherein the identifying the predetermined categories associated with the plurality of data files and the training the machine-learning system on the same number of data files for each identified category occurs after providing metadata associated with the plurality of data files to the machine-learning system and before splitting the plurality of data files into the training data set, the testing data set, and the validation data set.

17. The computer-readable storage medium of claim 15, wherein the predetermined categories comprise eight categories;
wherein the eight categories comprise or are otherwise associated with plants, mammals, insects, amphibians, fish, birds, tree bark, and snails; and
wherein the species comprise one of a plant species, a mammal species, an insect species, an amphibian species, a fish species, a bird species, a tree bark species, and a snail species.

18. A non-transient computer-readable storage medium having instructions embodied thereon, the instructions being executable by one or more processors to perform a method for identifying an object in a photograph, the method comprising:
sending an initial request to identify the object in the photograph from a user device to an application programming interface (API);
generating, at the API, a pre-signed uniform resource locator (URL) associated with a storage system;
generating metadata associated with the initial request;
sending an initial response to the initial request;
uploading the photograph from a user device directly to a location associated with the pre-signed URL;
sending a second request to identify the object in the photograph from the user device to the API;
providing a second response to the second request;
obtaining the photograph from the storage system;
using the photograph to invoke a first trained model from a machine learning system endpoint;
using the photograph to invoke a second trained model from the machine learning system endpoint;
obtaining from the second trained model a list of one or more most likely identification probabilities associated with the object;
updating the metadata associated with the object at the API;
sending a third request from the user device to the API, wherein the third request comprises a request to receive information associated with the list of one or more most likely identification probabilities; and
displaying at the user device one or more of the list of one or more most likely identification probabilities associated with the object, and information associated with the one or more of the list of one or more most likely identification probabilities associated with the object.

19. The computer-readable storage medium of claim 18, wherein the initial response comprises one of a response comprising the pre-signed URL and at least a portion of the metadata, or a response denying the request;
wherein the storage system comprises a cloud-based image storage system;
wherein the metadata comprises one or more of an image path, geographic location information associated with the photograph, user identification information, timing information, and a status of the request;
wherein the second request includes at least a portion of the metadata;
wherein the second response informs the user device from the API that the image is being processed;
wherein the method obtaining the photograph from the storage system comprises using the metadata at the API to locate the photograph on the cloud-based image storage system;
wherein using the photograph to invoke a first trained model from a machine learning system endpoint comprises invoking the first trained model by the API;
wherein the first trained model comprises a parent model;
wherein the second trained model comprises a child model; and
wherein using the photograph to invoke the second trained model from the machine learning system endpoint comprises using the parent model to invoke the child model.

20. The computer-readable storage medium of claim 19, wherein the response denying the request is provided when at least one of the API fails to identify at least one photograph due to an account setting associated with the photograph preventing identifying the photograph, and a security setting preventing identifying the photograph;
wherein the image path comprises a data string identifying a location where the photograph is stored;
wherein the user identification information comprises one or more of a data string associated with a user, a timestamp, and a data string associated with the request;
wherein the status of the request comprises a first status, a second status, a third status, and a fourth status;
wherein the cloud-based image storage system comprises Amazon Simple Storage Service (S3);
wherein at least one of the metadata and the photograph are located in a cache associated with the cloud-based image storage system;
wherein the parent model identifies a category associated with the object;
wherein the child model identifies at least one species associated with the category associated with the object;
wherein the list of one or more most likely identification probabilities is not received when the machine learning system is unavailable; and
wherein updating the metadata associated with the object comprises:
changing a status of the request to the third status,
providing a period of time associated with the period between sending the initial request to identify the object in a photograph and invoking the first trained model from the machine learning system endpoint, and
providing a period of time associated with the period between sending an initial request to identify the object in a photograph and invoking the second trained model from the machine learning system endpoint.
